(19) United States
(12) Patent Application Publication
(10) Pub. No.: US 2001/0054126 A1
(43) Pub. Date: Dec. 20, 2001

(54) SIMD type processor, method and apparatus for parallel processing, devices that use the SIMD type processor or the parallel processing apparatus, method and apparatus for image processing, computer product

(75) Inventors: Hiroaki Fukuda, Kanagawa (JP); Yoshiyuki Namizuka, Kanagawa (JP); Yuji Takahashi, Kanagawa (JP); Yasuyuki Nomizu, Kanagawa (JP); Fumio Yoshizawa, Tokyo (JP); Sugitaka Oteki, Tokyo (JP); Takeharu Tone, Tokyo (JP); Rie Ishii, Tokyo (JP); Hideto Miyazaki, Kanagawa (JP); Shinya Miyazaki, Tokyo (JP); Hiroyuki Kawamoto, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: RICOH COMPANY, LIMITED, Ohta-ku (JP)

(21) Appl. No.: 09/801,843

(22) Filed: Mar. 9, 2001

(30) Foreign Application Priority Data
Mar. 27, 2000 (JP) 2000-087580

(51) Int. Cl. G06F 13/24

(52) U.S. Cl. 710/260

(57) ABSTRACT

A SIMD type processor includes a SIMD type arithmetic processing section which performs parallel processing by using a plurality of ALUs; and a global processor 102 that provides data to be arithmetically processed to a register and a data register group and provides the same instruction to each of the ALUs. Upon input of an interruption request for carrying out other parallel processing by interrupting a parallel processing currently carried out by the SIMD type arithmetic processing section, the global processor decides if the other parallel processing requested by the interruption request is to be carried out. The global processor suspends the parallel processing currently being carried out, when necessary. Then, the global processor provides data to be arithmetically processed by the interruption processing to the register and the data register group, and provides the same instruction necessary for carrying out the interruption processing to each of the ALUs.

### FIELD OF THE INVENTION

The present invention in general relates to a SIMD type processor, a method and apparatus for parallel processing, a method and apparatus for image processing, devices that use the SIMD type processor or the parallel processing apparatus, a method and apparatus for image processing, and a computer-readable recording medium that records computer program for making a computer execute these methods according to the present invention. More particularly, this invention relates to a technology of carrying out parallel processing of high priority order with priority.

### BACKGROUND OF THE INVENTION

Conventionally, a processor has carried out various kinds of processing in a computer. The processor fetches an instruction to be executed from a memory, decodes this instruction, and then executes the decoded instruction. In this way, the processor has repeated the processing of a set of instructions many times. Based on a combination of various kinds of instructions, the processor can execute a desired processing according to a program.

In other words, the conventional processor generates a flow of single instructions for processing a flow of single data, and thus repeats many times a cycle of processing a single data based on a simple instruction. It has been possible to execute a complex processing by combining the contents of operation. This processing system has been known as the Von-Neumann-type computer processing.

FIG. 32 is a schematic block diagram showing an example of a portion that becomes the center of arithmetic processing of the conventional processor. A processor 3200 includes an execution unit 3203 consisting of an ALU (arithmetic logic unit) 3201 and a register 3202, and a controller 3204 for giving a processing instruction to the execution unit 3203 and controlling the execution unit 3203 and the like. The processor 3200 inputs data to be processed from the outside of the processor, processes the data, and output the processed data.

A Von-Neumann-type processor is effective in the sequential processing for sequentially carrying out a processing by reflecting data and past calculation results stored in a memory. An example of an application of a processor that carries out the Von-Neumann-type processing will be explained based on a digital multi-functional apparatus for carrying out various image processing.

FIG. 33 is a block diagram showing an example of a hardware structure of a digital multi-functional apparatus relating to a prior-art technique. The digital multi-functional apparatus is constructed of two portions of a copying portion (a copier portion) and other additional units as shown in FIG. 33. The copier portion is formed by a series of parts including a reading unit 3301, an image processing unit 3302, a video control section 3303, a writing unit 3304, a memory control unit 3305, and a memory module 3306. The additional parts are a facsimile control unit 3312, a printer control unit 3313, and a scanner control unit 3314 that are additionally connect to the copier portion via a mother board 3311. Based on this structure, each function of the digital multi-functional apparatus is achieved.

A series of operations of the reading unit 3301, the image processing unit 3302, the video control section 3303, and the writing unit 3304, for achieving the functions of the copier portion, have been controlled by a system controller 3307, a RAM 3308, and a ROM 3309. On the other hand, the facsimile control unit 3312, the printer control unit 3313, and the scanner control unit 3314 have achieved their functions by utilizing a part of the established series of operations of the copier.

In other words, the functions of the digital multi-functional apparatus have been achieved by adding the facsimile control unit 3312, the printer control unit 3313, and the scanner control unit 3314 to the copier portion that has been established as one system by the above-described series of parts. This has been based on the background that a greater importance is attached to the processing speed (that is, increasing the processing speed) by constructing the series of parts with hardware of an ASIC (application specific integrated circuit) and the like.

Regarding the image processing, the image processing unit 3302, the facsimile control unit 3312, and the printer control unit 3313 carry out this processing. Depending on the structure of the apparatus, there is also a case where the image data input from the facsimile control unit 3312 is transferred to the image processing unit 3302, and the image processing unit 3302 processes the image.

In this case, a sequential processing type processor can execute a high-priority processing by placing priority to this processing through monitoring the presence of an interruption request. As there is only one ALU, it is always important to make a decision about which instruction is to be executed next. Therefore, a contention of processing arises among a plurality of processing requests in the digital multi-functional apparatus, it is possible to carry out an efficient image processing by applying the conventional sequential processing type processor.

As examples of this type of digital multi-functional apparatus, there have been known “An interruption control system for an integrated information processing apparatus” as disclosed in Japanese PatentApplication Laid-Open (JP-A) No. 6-110704, and “An image processing apparatus” as disclosed in Japanese Patent Application Laid-Open (JP-A) No. 9-55821.

In the mean time, different from the Von-Neumann-type processing system, there has also been considered a processing system that processes different data flows by giving the same instruction to a plurality of processor elements (PE). This processing system of processing one vector in one instruction cycle is classified as the SIMD (single instruction stream multiple data stream) type, and this system is effective for what is called a parallel calculation. A processor that efficiently executes the SIMD type processing will hereinafter be referred to as a SIMD type processor.

FIG. 34 is a schematic block diagram showing an example of a portion that becomes the center of arithmetic processing of the SIMD type processor. The SIMD type processor 3400 has a plurality of execution units 3403 each consisting of an ALU 3401 and a register 3402. The SIMD type processor 3400 also includes a controller 3404 that gives the same processing instruction to the plurality of execution units 3403 and controls these execution units 3403 and the like. The SIMD type processor 3400 inputs a group of data to be processed from the outside, processes the data, and outputs the group of processed data.

The SIMD type processor has such an advantage that it is possible to reduce the calculation time at the time of collectively processing a large number of equivalent data (vector data) like image data that is structured by many pixels. In recent years, there is a trend of increase in the size of pixel data that is processed equivalently in line with a trend of high pixels of a digital camera and the like. In general, the SIMD type processor has an advantage over the Von-Neumann-type processor in that the SIMD type processor can process data faster than the Von-Neumann-type processor when the number of pixels becomes larger in the case of carrying out the same processing. Therefore, the SIMD type processor is suitable for processing the image data of the digital camera.

In the case of the digital multi-functional apparatus shown in FIG. 33, when the data transmitted to the facsimile control unit 3313 is data having a large number of pixels, the use of the SIMD type processor in this facsimile control unit 3313 makes it possible to carry out a high-speed image processing.

However, the conventional SIMD type processor and the conventional digital multi-functional apparatus have had the following problems. First, in the case of the conventional digital multi-functional apparatus, the copier portion has been established as one system as described above. Therefore, it has been necessary that the facsimile control unit 3312, the printer control unit 3313, and the scanner control unit 3314 that are connected to the copier need to construct a system independent of the copier portion in order to achieve the respective functions.

As a result, there has been a problem that each control unit has a duplicated apparatus structure, which has been wasteful. For example, the facsimile control unit 3312 carries out a certain level of image processing, and the writing unit 3304 writes the processed data onto a transcription sheet via the video control section 3303. Among this image processing, some image processing is also carried out by the image processing unit 3302. Thus, the apparatus has had a duplicated structure of carrying out the same processing, which has been a waste.

This duplicated structure of the apparatus has been present not only in the image processing unit but also in the memory module that is necessary for achieving the function of each unit. Each unit has not effectively utilized the memory module 3306 held by the copier portion, and each unit has its own memory module, which has been a duplication and has invited an increase in size and an increase in cost of the apparatus as a whole.

Further, as the copier portion has been established as one system, there has been a problem that it is not possible to efficiently improve the functions along the improvement in the performance of the peripheral units. Therefore, it has not been easy to change only the reading unit 3301 or the writing unit 3304. For example, when it is desired to change the reading unit 3301 or the writing unit 3304 having a capacity of 400 dpi to each unit having the capacity of 600 dpi, a simple replacement of the unit does not improve the functions of the apparatus as a whole.

In other words, the series of the system have already been established to write and read based on 400 dpi as the whole copier portion. Therefore, in order to change a unit, it is necessary to change a threshold value and others for the intermediate processing. Further, there is a case where the set contents of other units also need to be changed to be able to read and write based on 600 dpi.

As a result, when the apparatus has been constructed of hardware like the ASIC, it is necessary to replace the hardware itself (that is, the customized ICs andLSIs, etc.). This means that only the replacement of a peripheral unit along the improvement in the performance of the peripheral unit cannot easily improve the functions of the apparatus as a whole.

As explained above, the conventional digital multi-functional apparatus has had a problem in that it is not possible to provide an optimum control structure for effectively utilizing resources of the system such as the improvement in the functions by sharing the modules and replacing the units, and the division of a plurality of functions.

Consider a case of constructing an image processing unit that mainly carries out an image processing based on the assumption that the module and others can be shared and the functional units can be made independent. For the image processing unit, it is advantageous to use the SIMD type processor in order to cope with a future version-up of other functional units corresponding to the increase in the size of pixels to be handled. In other words, it is considered advantageous to use the SIMD type processor that carries out the same processing to each pixel without waiting for the processing of other pixels.

The arithmetic processing is carried out continuously until a program finishes in consideration of the fact that the SIMD type processor can carry out a fast processing. In the case of processing 100 pixel data, the Von-Neumann-type processor requires 100-unit time when the processing of one pixel requires one unit time, as this processor processes each one pixel sequentially. On the otherhand, the SIMD type processor can process the 100 pixels in one unit time when 100 PEs are provided. Thus, it is considered there is no inconvenience in continuously carrying out the arithmetic processing by the SIMD type processor.

However, when the arithmetic processing is continued until the program finishes, there arises the following problem. While an image processing relating to a facsimile reception is being carried out, a copying processing may become necessary. In this case, the use of the SIMD type processor in the image processing unit has had a problem that it is not possible to carry out the copying processing until when the image processing relating to the facsimile reception has been finished. In other words, even when a request has been made for using the SIMD type processor in order to carry out a high-speed processing of image data having a large number of pixels, it is not possible to actually carry out the next processing until when a predetermined processing has been finished when a contention exists among a plurality of processing. As a result, it has not been possible to carry out an efficient parallel processing.

### SUMMARY OF THE INVENTION

It is one object of this invention to provide a technology with which it is possible to efficiently carry out the parallel processing.

It is an another object of the present invention to provide a technology with which it is possible to carry out an optimum image processing of a system as a whole while effectively utilizing resources of the system that achieves multi functions.

The SIMD type processor according to one aspect of this invention comprises a parallel processing unit that carries out a parallel processing using a plurality of 15 arithmetic units which carry out an arithmetic processing to given data; a data providing unit that provides data to be arithmetically processed to the parallel processing unit;

an instruction providing unit that provides the same instruction for carrying out the arithmetic processing to each of the arithmetic unit; an input unit that inputs an interruption request for carrying out other parallel processing by interrupting a parallel processing currently carried out by the parallel processing unit; a decision unit that makes a decision as to whether a parallel processing requested by the interruption request input from the input unit is to be carried out or not; a suspending unit that suspends a parallel processing currently being carried out by the parallel processing unit when the decision unit has decided that the interruption processing is to be carried out; and a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

The parallel processing apparatus according to another aspect of this invention comprises a parallel processing unit that carries out a parallel processing using a plurality of arithmetic units which carry out an arithmetic processing to given data; a data providing unit that provides data to be arithmetically processed to the parallel processing unit; an instruction providing unit that provides the same instruction for carrying out the arithmetic processing to each of the arithmetic unit; an input unit that inputs an interruption request for carrying out other parallel processing by interrupting a parallel processing currently carried out by the parallel processing unit; a decision unit that makes a decision as to whether a parallel processing requested by the interruption request input from the input unit is to be carried out or not; a suspending unit that suspends a parallel processing currently being carried out by the parallel processing unit when the decision unit has decided that the interruption processing is to be carried out; and a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

The image processing apparatus according to still another aspect of this invention comprises an image data control unit that is connected to an image memory control unit that controls an image reader that reads image data and/or an image memory thereby to write/read image data, and/or b) an image writer that writes image data onto a transcription sheet; and an image processing unit that carries out an image processing of image data such as an editing of image data; that receives at least third image data out of first image data that has been read by the image reader, second image data that has been read by the image memory control unit, and the third image data that has been image processed by the image processing unit; and that transmits at least the third image data out of the first image data, the second image data, and the third imaged data, to the image memory control unit and/or the image processing unit and/or the image writer, wherein at least the image processing unit out of all the units has the SIMD type processor or the parallel processing apparatus according to the present invention.

The image processing apparatus according to still another aspect of this invention comprises an image memory control unit that is connected to an image reader that reads image data and/or an image writer that writes image data onto a transcription sheet; and an image processing unit that carries out an image processing of image data such as an editing of image data; that receives at least second image data out of first image data that has been read by the image reader, and the second image data that has been image processed by the image processing unit; and that stores at least the second image data out of the first image data and the second image data, into an image memory, and transmits the image data stored in the image memory to the image processing unit and/or the image writer, wherein at least the image processing unit out of all the units has the SIMD type processor or the parallel processing apparatus according to the present invention.

The image processing apparatus according to still another aspect of this invention comprises an image processing unit that is connected to an image reader that reads image data and/or image memory a control unit that controls an image memory to write/read image data and/or an image writer that writes image data onto a transcription sheet, that receives first image data that has been read by the image reader and/or second image data that has been read by the image memory control unit, and that carries out an image processing of the first image data and/or the second image data such as an editing of image data, and transmits the image-processed image data to the image memory control unit and/or the image writer, wherein at least the image processing unit out of all the units has the SIMD type processor or the parallel processing apparatus according to the present invention.

The copier according to still another aspect of this invention comprises the SIMD type processor or the parallel processing apparatus according to the present invention.

The printer according to still another aspect of this invention comprises the SIMD type processor or the parallel processing apparatus according to the present invention.

The facsimile machine according to still another aspect of this invention comprises the SIMD type processor or the parallel processing apparatus according to the present invention.

The scanner according to still another aspect of this invention comprises the SIMD type processor or the parallel processing apparatus according to the present invention.

The parallel processing method according to still another aspect of this invention comprises a data providing step of providing data to be processed as a parallel processing; an instruction providing step of providing an instruction necessary for carrying out the parallel processing; a parallel-processing step of carrying out a parallel processing of the data provided at the data providing step, based on the instruction provided at the instruction providing step; an input step of inputting an interruption request for carrying out other parallel processing by interrupting a parallel processing currently carried out at the parallel-processing step; a decision step of making a decision as to whether an interruption processing of the parallel processing requested at the input step is to be carried out or not; a suspending step of suspending a parallel processing currently being carried out at the parallel-processing step when a decision has been made at the decision step that the interruption processing is to be carried out; and a replacing step of providing data to be parallel processed by the interruption processing and an instruction necessary for carrying out the interruption processing, in place of the parallel processing suspended at the suspending step.

The parallel processing method according to still another aspect of this invention comprises an image data receiving step of receiving image data from any one processing unit out of a plurality of processing units that carry out different kinds of processing of image data such as an image data reading processing, an image data storing processing, an image (editing) processing, and a transmission/reception processing; an image data control information obtaining step of obtaining image data control information that includes information relating to the contents of processing of the image data received at the image data receiving step; a transmission destination processing unit determining step of determining a processing unit at a transmission destination to which the image data received at the image data receiving step is to be transmitted, based on the image data control information obtained at the image data control information obtaining step; and a transmission step of transmitting the image data to the transmission destination processing unit that has been determined at the transmission destination processing unit determining step, wherein the processing of the image data in at least one processing unit among the plurality of processing units includes the parallel processing method according to the present invention.

The computer readable recording medium according to another aspect of the present invention stores a computer program which when executed realizes the parallel processing method and the image processing method according to the present invention.

Other objects and features of this invention will become apparent from the following description with reference to the accompanying drawings.

### BRIEF DESCRIPTION OF THE DRAWINGS

FIG. 1 is a diagram showing an example of a structure of a SIMD type processor relating to a first embodiment of the present invention.

FIG. 2 is a flowchart for explaining the operation of the SIMD type processor relating to the first embodiment.

FIG. 3 is a flowchart for explaining a save and a return of the processing in the SIMD type processor relating to the first embodiment.

FIG. 4 is a schematic diagram showing a state of storing suspension information of job 2 into a data RAM under a control of a global processor.

FIG. 5 is a schematic diagram showing a state of returning suspension information stored in a data RAM under a control of a global processor.

FIG. 6 is a diagram showing an example of a processing program stored in a program RAM.

FIG. 7A and FIG. 7B are conceptual diagrams showing an example of a state of using a data RAM.

FIG. 8 is a diagram showing an example of a structure of a parallel processing apparatus relating to a second embodiment of the invention.

FIG. 9 is a functional block diagram showing a structure of an image processing apparatus relating to a third embodiment of the invention.

FIG. 10 is a block diagram showing an example of a hardware structure of the image processing apparatus relating to the third embodiment.

FIG. 11 is a functional block diagram showing the outline of the processing of an image processing processor of the image processing apparatus relating to the third embodiment.

FIG. 12 is a block diagram showing an internal structure of the image processing processor of the image processing apparatus relating to the third embodiment.

FIG. 13 is a block diagram showing a detailed internal structure of the image processing processor shown in FIG. 12.

FIG. 14 is an explanatory diagram showing the outline structure of a SIMD type arithmetic processing section relating to the third embodiment.

FIG. 15 is an explanatory diagram for explaining a method of storing in a register capable of carrying out a sequential processing in the SIMD type processor relating to the third embodiment.

FIG. 16 is a block diagram showing the outline of the processing of an image data control section of the image processing apparatus relating to the third embodiment.

FIG. 17 is a block diagram showing the outline of the processing of a video data control section of the image processing apparatus relating to the third embodiment.

FIG. 18 is a block diagram showing the outline of the processing of an image memory access control section of the image processing apparatus relating to the third embodiment.

FIG. 19 is a block diagram showing an example of unit structures when the image processing apparatus is a digital multi-functional apparatus.

FIG. 20 is an explanatory diagram showing the outline of a scanner (an example of a space filter) of the image processing apparatus relating to the third embodiment.

FIG. 21 is an explanatory diagram showing the outline of a shading correction of the image processing apparatus relating to the third embodiment.

FIG. 22 is an explanatory diagram showing the outline of shading data of the image processing apparatus relating to the third embodiment.

FIG. 23 is an explanatory diagram showing a data flow of an image processing apparatus as a digital multi-functional apparatus involving an image storing processing for storing an image into a memory module relating to the third embodiment.

FIG. 24 is an explanatory diagram showing a data flow of an image processing apparatus as a digital multi-functional apparatus involving an image storing processing for storing an image into a memory module relating to the third embodiment.

FIG. 25 is block diagram showing a structure of a facsimile control unit of the image processing apparatus relating to the third embodiment.

FIG. 26 is a flowchart showing a procedure of a series of processing in an image processing method relating to the third embodiment.

FIG. 27 is a block diagram showing another example of a hardware structure of the image processing apparatus relating to the third embodiment.

FIG. 28 is a block diagram showing another example of a hardware structure of the image processing apparatus relating to the third embodiment.

FIG. 29 is a diagram showing an example of a structure of an apparatus as a single printer.

FIG. 30 is an explanatory diagram showing a data flow of an image processing apparatus as a single printer involving an image storing processing for storing an image into a memory module relating to the third embodiment.

FIG. 31 is an explanatory diagram showing a data flow of an image processing apparatus as a single printer involving an image storing processing for storing an image into a memory module relating to the third embodiment.

FIG. 32 is a schematic block diagram showing an example of a portion that becomes the center of arithmetic processing of a conventional processor.

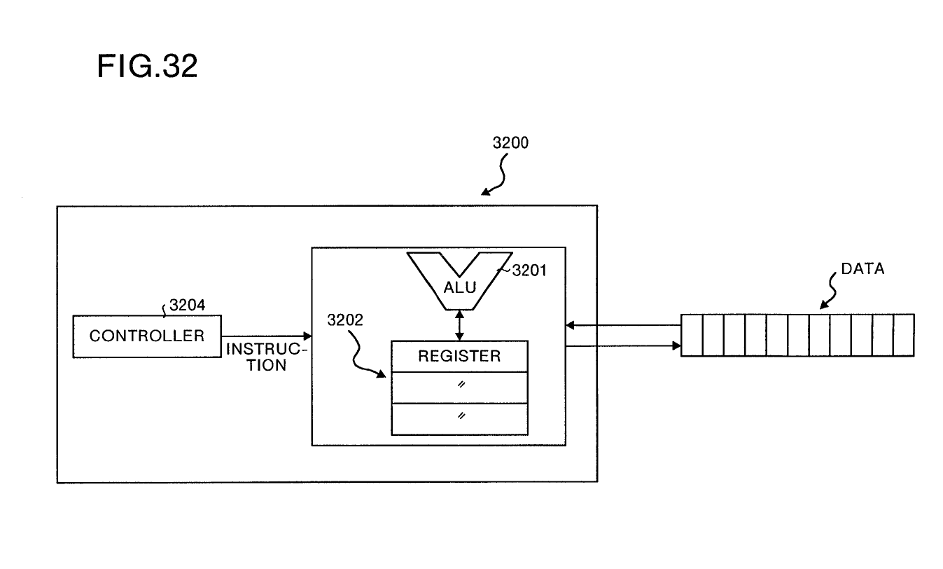

FIG. 33 is a block diagram showing an example of a hardware structure of a digital multi-functional apparatus relating to a prior-art technique.

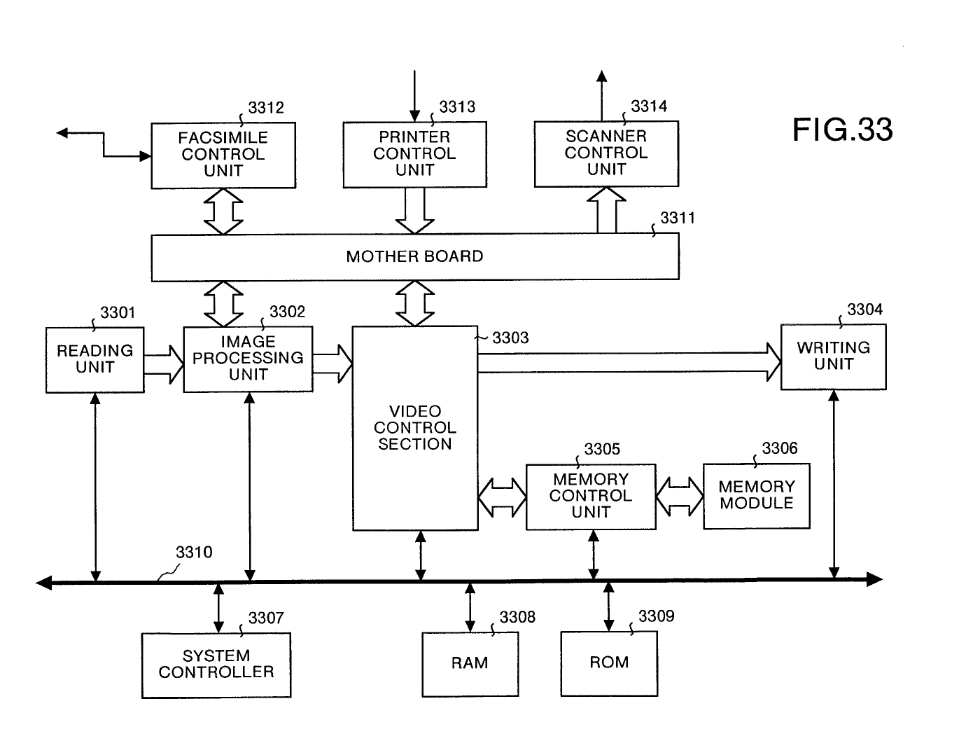

FIG. 34 is a schematic block diagram showing an example of a portion that becomes the center of arithmetic processing of a SIMD type processor.

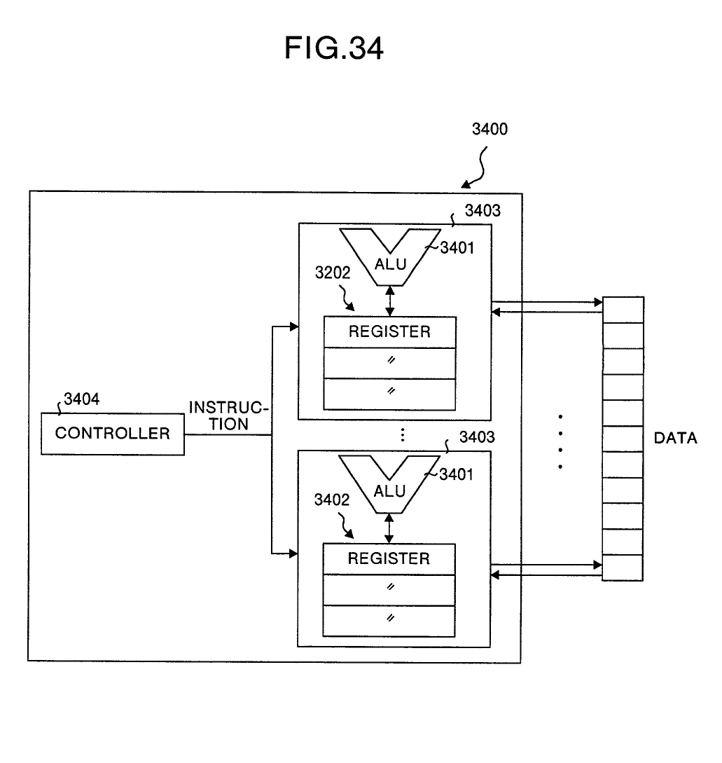

### DESCRIPTION OF THE PREFERRED EMBODIMENTS

Preferred embodiments of a SIMD type processor, a method and apparatus for parallel processing, a method and apparatus for image processing, devices that use the SIMD type processor or the parallel processing apparatus, a method and apparatus for image processing, and a computer-readable recording medium that records computer program for making a computer execute these methods according to the present invention, will be explained in detail below with reference to the accompanying drawings.

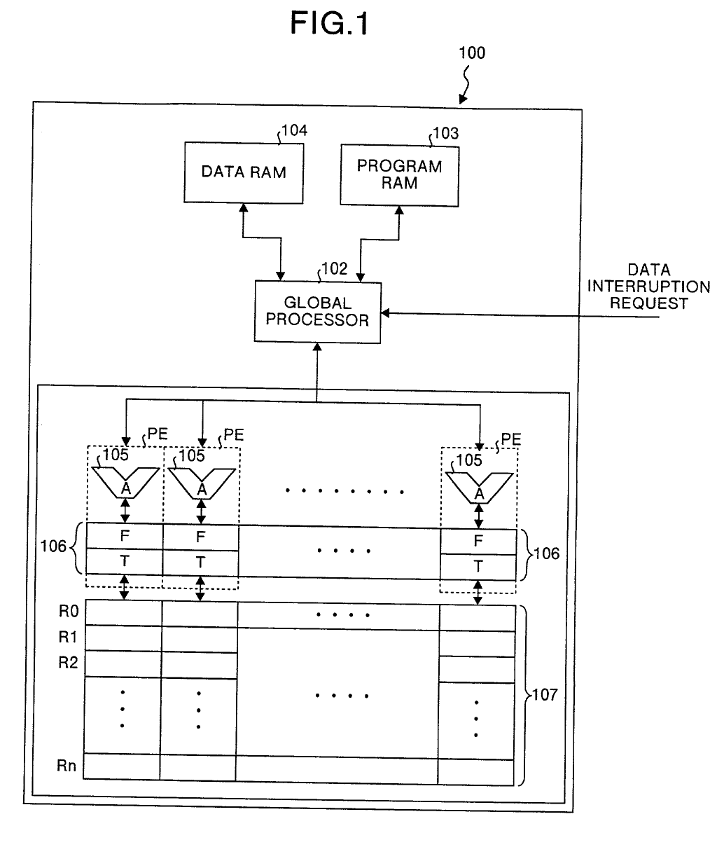

To begin with, a SIMD type processor relating to a first embodiment of the invention will be explained. FIG. 1 is a diagram showing an example of a structure of a SIMD type processor relating to the first embodiment of the invention. This SIMD type processor 100 consists of a SIMD type arithmetic processing section 101 for carrying out a parallel processing to given data, a global processor 102 for providing data and an instruction to be processed to the SIMD type arithmetic processing section 101, a program RAM 103 for storing an instruction necessary for the parallel processing, and a data RAM 104 for storing parameter data necessary for executing the instruction in the SIMD type arithmetic processing section 101, and for storing data and a state of the SIMD type arithmetic processing section 101 and data and a state within the global processor 102.

The SIMD type arithmetic processing section 101 consists of a plurality of ALUs (arithmetic logic unit) 105 for arithmetically processing given data, registers 106 corresponding to the ALUs respectively, each register 106 made up of a temporary register F for storing data to be processed by the ALU 105 and a condition register T, and data registers RO to Rn for storing other data for a parallel processing.

Hereinafter, the data registers RO to Rn will be collectively called a data register group 107, and each ALU is assumed to include an accumulator A. Further, each ALU 105 and each register 106 will hereinafter be collectively called a processor element (PE).

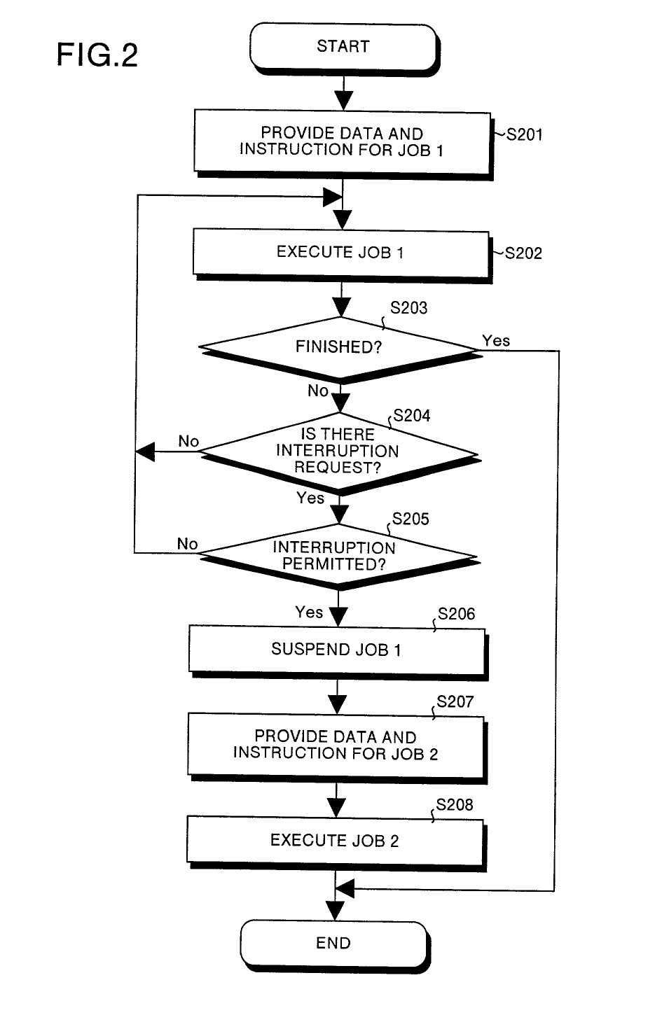

The SIMD type processor 100 receives an interruption request, and replaces a processing of the SIMD type arithmetic processing section 101 with a processing requested by this interruption request when necessary. The operation of the SIMD type processor 100 including the interruption request processing will be explained below. FIG. 2 is a flowchart for explaining the operation of the SIMD type processor 100. The global processor 102 provides the ALU 105 with an instruction relating to a job 1 stored in the program RAM 103, and also provides the temporary register F with data that is necessary for the processing from the outside of the SIMD type processor 100 (step S201).

In this case, the job is a unit of work defined by a programmer and is executed by the SIMD type processor 100. An instruction provided by the global processor 102 is distributed to all the ALUs 105 in a similar manner. In other words, one instruction or instructions are broadcast equally to all the ALUs 105 so that the SIMD type arithmetic processing section 101 can carry out a parallel processing.

The data provided by the global processor 102 is not limited to the data supplied from the outside. Instead, the data may also be read directly or indirectly from the data register R into the temporary register F according to an instruction given to the ALU 105, for example. Alternately, a plurality of data to be used may be read out and stored in the data register group 107 in advance.

Based on the data and the instruction given at step S201, the SIMD type arithmetic processing section 101 executes the job 1 (step S202). An intermediate result of calculation may be stored in the register 106 and the data register group 107 when necessary. The global processor 102 makes a decision as to whether the SIMD type arithmetic processing section 101 has finished the job 1 or not (step S203).

The global processor 102 makes this decision about whether the job 1 has been finished or not, based on a program counter value. A program counter is an exclusive register for storing a program counter value that is a value for showing to what stage the processing of the job 1 has been progressed. This program counter not shown is provided inside the global processor 102. Depending on the using mode, the program counter may be provided inside the SIMD type arithmetic processing section 101 so that the global processor 102 refers to the program counter value from time to time.

When the job 1 has been finished (YES at step S203), the SIMD type processor 100 finishes the processing. When the job 1 has not yet been finished (NO at step S203), the SIMD type processor 100 checks whether there is an interruption request or not (step S204). In this case, the interruption request refers to a request for carrying out a separate processing different from a series of program processing executed by the job 1. When the SIMD type processor 100 carries out a processing not limited to a specific application, it is necessary to receive a request for carrying out other processing, and the global processor 102 inputs an interruption request signal.

When there has been no interruption request (NO at step S204), the process returns to step S202, and the job 1 is continued. On the other hand, when there has been an interruption request (YES at step S204),the global processor 102 makes a decision as to whether the interruption is to be permitted or not (step S205). The global processor 102 makes this decision based on a comparison between the priority of the job 1 currently being processed and the priority of the parallel processing relating to the interruption request. This priority may be defined within the processing program of the job 1. A comparison table may also be provided for making the comparison.

When the interruption request is not permitted (NO at step S205), the process returns to step S202, and the job 1 is continued. The global processor 102 may transmit a signal to show that the interruption request has been abandoned, to a transmission originator of the interruption request. When the interruption request is to be permitted (YES at step S205), the global processor 102 stops the job 1 (step S206). A stop signal is broadcast from the global processor 102 to each ALU 105. For example, an interruption request flag is set. In this case, the SIMD type arithmetic processing section 101 carries out the same processing at each ALU 105 at the same timing. Therefore, it is possible to start the job 1 at the same time and to stop the processing at the same time.

The global processor 102 provides the SIMD type arithmetic processing section 101 with an instruction and data of a job 2 relating to the interruption request (step S207). The instruction of the job 2 is stored in the program RAM 103. Depending on the using mode, the instruction may be input from the outside of the SIMD type processor 100. While the data is also input from the outside of the SIMD type processor 100, the data of the data register group 107 may be used directly as it is, depending on the contents of the job 2.

When it takes some time for inputting the data from an external bus of the SIMD type processor 100, the data may be temporarily stored in the data RAM 104 depending on the needs. With this arrangement, it is possible to continue the processing of the job 1 to the last moment. After stopping the processing, the data of the job 2 can be stored quickly into the data register group 107.

When the provision of the data and the instruction has been finished at step S207, the job 2 is executed (step S208). In the above, a description has been made of the case where there is the interruption request of the job 2 during the execution of the job 1. The interruption request is not limited to this. When there is other interruption request during the interruption processing of the job 2, it is also possible to carry out the processing in a similar manner to that described above.

As explained above, the SIMD type processor 100 can execute a processing having a high priority by placing the priority to this processing. Therefore, it is possible to utilize the SIMD type processor 100 as a general-purpose processor. Particularly, as the SIMD type processor 100 carries out a parallel processing, it is possible to finish the processing of all the PEs at the same time and to quickly set the processing state to a state capable of executing the parallel processing of the interruption processing. Further, as the program of the job 2 exists within the program RAM 103, there is an advantage that it is possible to instantly execute the job 2.

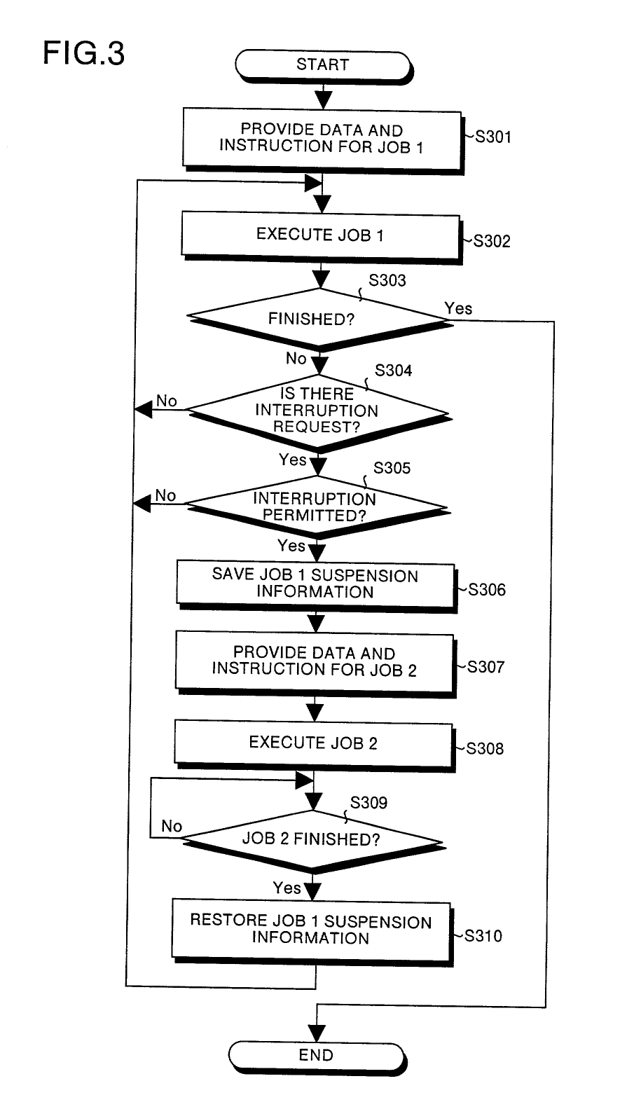

Next, the processing flow for restarting the processing of the job 1 after finishing the processing of the job 2 using the data RAM 104 will be explained. FIG. 3 is a flowchart for explaining a save and a return of the processing in the SIMD type processor 100. The processing at step S301 to step S305 is similar to that from step S201 to step S205 shown in FIG. 2, and therefore, their explanation will be omitted.

When the interruption is to be permitted at step S305 (YES at step S305), suspension information of the job 1 is saved in the data RAM 104 (step S306). The suspension information consists of the program counter value within the global processor 102, the contents of each PE, that is, the contents of the accumulator A of the ALU 105 and the contents of the register 106, and the contents of the data register group 107. The suspension information can be said to be what is called a hard copy of the SIMD type processor 100. The suspension information is saved under the control of the global processor 102.

When the storing of the suspension information has been finished, the global processor 102 provides the SIMD type arithmetic processing section 101 with the data and the instruction of the job 2 in a similar manner to that at step S207 and step S208 shown in FIG. 2 (step S307). The SIMD type arithmetic processing section 101 executes the job 2 (step S308). Next, the global processor 102 makes a decision as to whether the job 2 has been finished or not based on the program counter value (step S309).

When the processing of the job 2 has not yet been finished (NO at step S309), the processing of the job 2 is continued. The processing of a case when there has been an interruption processing request during a continued processing of the job 2 will be explained later. When the processing of the job 2 has been finished (YES at step S309), the suspension information of the job 2 is restored (step S310). The restoration is carried out by restoring the suspension information stored in the data RAM 104 to their original positions. The global processor 102 carries out this restoration processing.

As the suspension information includes the contents of the parallel processing at a point of time when the processing of the job 1 has been suspended, it is possible to continue the parallel processing from the point of the suspension. In other words, when the suspension information has been restored at step S310, the process proceeds to step S302.

The above explains the processing procedure of saving the job 1 and executing the job 2, and then restarting the job 1 after finishing the job 2. Next, consider the case where there has been a further interruption request during the execution of the job 2. A parallel processing relating to this interruption processing will be called a job 3. The processing flow for executing the job 3 is similar to that shown in FIG. 3. The suspension information of the job 2 is stored (stacked) in the data RAM 104.

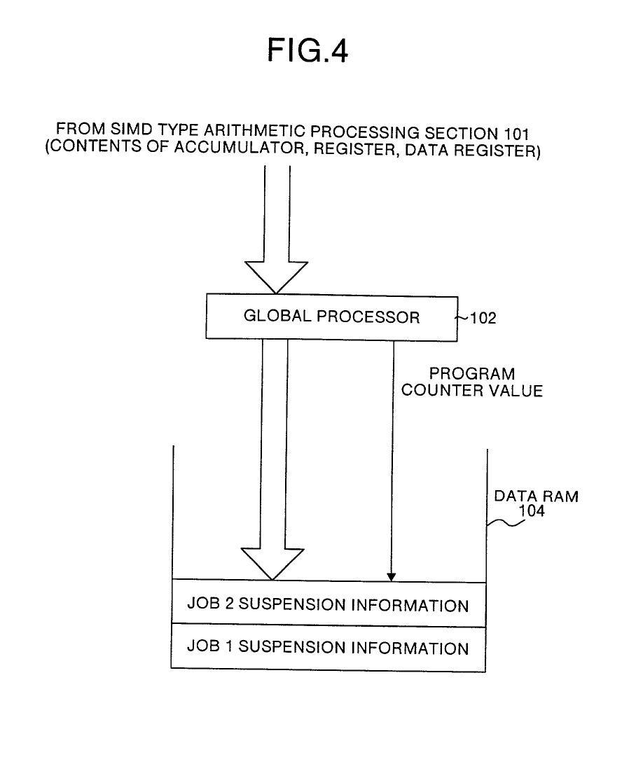

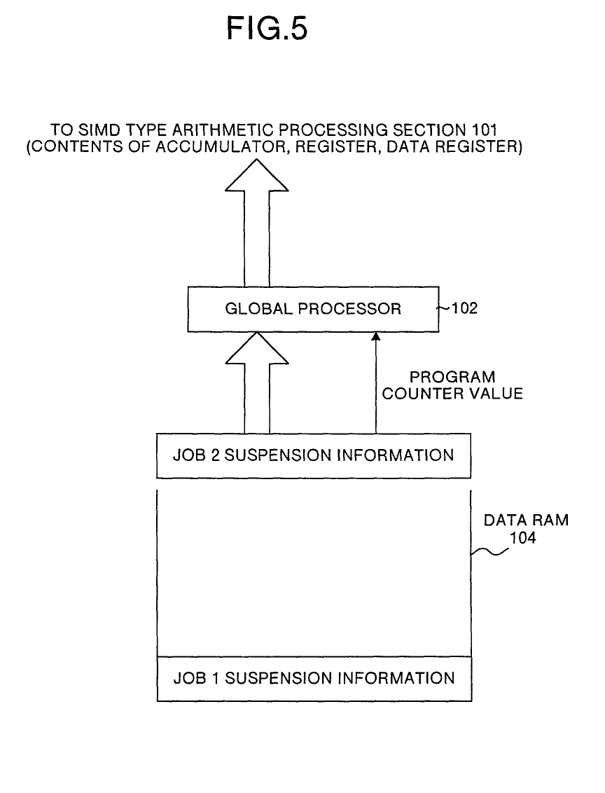

FIG. 4 is a schematic diagram showing a state of storing the suspension information of the job 2 into the data RAM 104 under the control of the global processor 102. FIG. 5 is a schematic diagram showing a state of returning the suspension information stored in the data RAM 104. In comparing the job 1 with the job 2, the priority of the job 2 has been decided to be higher than the priority of the job 1. Therefore, when the interruption processing of the job 3 has been finished, the suspension information of the job 2 must be restored, and the job 2 must be processed. Therefore, when the suspension information of the job stored last in the stack memory is read out first as shown in FIG. 4, it is easy to manage the memory.

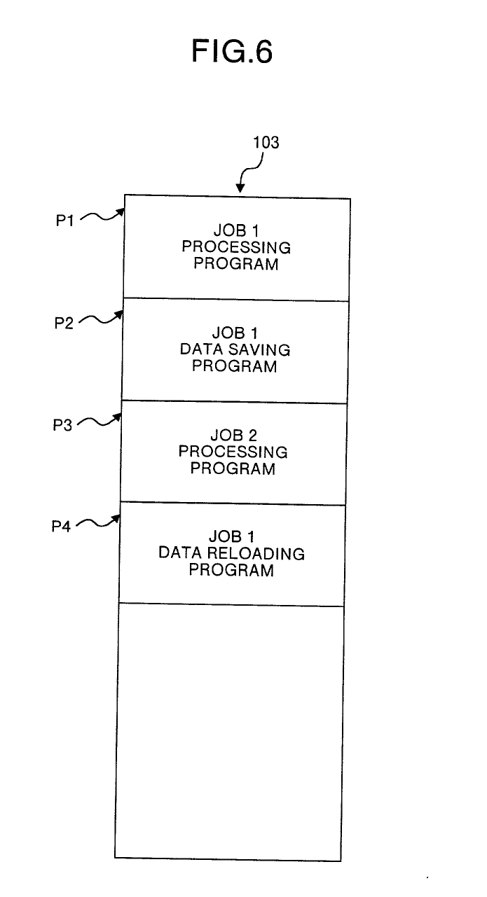

The above explains the outline of the processing of the SIMD type processor 100. Next, the contents of the program RAM 103 will be explained. FIG. 6 is a diagram showing an example of a processing program stored in the program RAM 103. The program RAM 103 stores a job 1 processing program p1 as a first program, stores a job 1 data saving program p2 (a program for storing the suspension information of the job 1) as a second program, stores a job 2 processing program p3 as a third program, and stores a job 1 data reloading program (a program for returning the suspension information of the job 1) p4 as a fourth program. An area after the p4 is an empty area.

The global processor 102 assigns the address of the p1 stored in the program RAM 103 by the program counter, and makes the job 1 executed. When the interruption request of the job 2 has occurred and when a decision has been made that this interruption processing is to be carried out, the program counter is advanced by one. Then, the global processor 102 assigns the address of the p2 stored in the program RAM 103, and makes the interruption processing executed.

Thereafter, the program counter is advanced sequentially to execute the p3 and the p4. After the processing of the job 2 has been finished, the processing of the job 1 is started again from the point of time when the job 1 has been suspended. While the program RAM 103 has the programs arrayed in the sequence of restarting the suspended processing, the program array order is not limited to this. The programs to be processed may be loaded based on the address assigned by the program counter values.

Further, while the program RAM 103 stores the processing programs assumed in advance, the processing programs to be stored in this program RAM are not fixed. The programs may be stored as an instruction set in a memory section (for example, a hard disk memory or a main memory) at the outside of the SIMD type processor 100, and these programs may be downloaded when necessary.

Based on the above-described structure, the SIMD type processor 100 can not only be utilized as a general-purpose parallel processing processor, but also can improve the processing speed of this processor by storing the processing programs inside the processor. Further, as the necessary processing programs can be used in combination, the SIMD type processor 100 be used as what is called a programmable processor, with extreme improvement in the convenience of the processor. Depending on the contents of the interruption processing, the contents of the program RAM 103 may also be stored in the data RAM 104 as the suspension information.

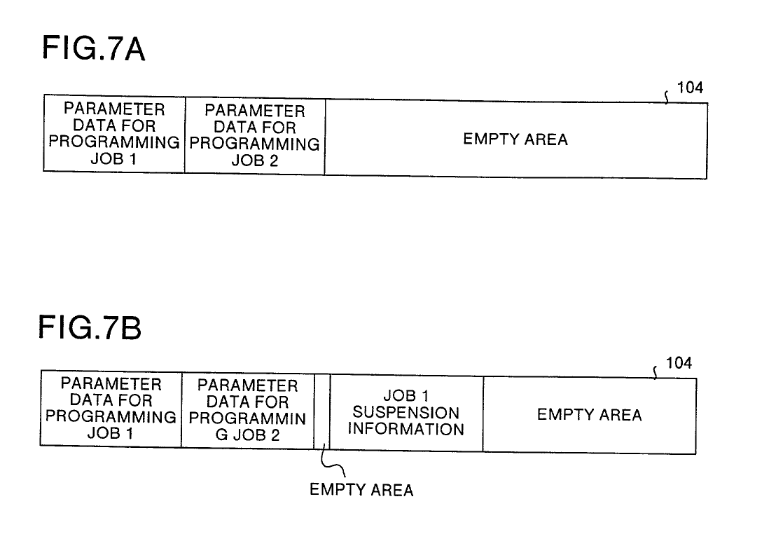

As the data RAM 104 stores parameters corresponding to the processing programs, it is possible manage the programs based on the address assignment instead of stacking the programs. FIG. 7A and FIG. 7B are concept diagrams showing an example of a state of using the data RAM 104. FIG. 7(a) shows a state before storing suspension information, and FIG. 7(b) shows a state after storing the suspension information. As shown in these diagrams, it is possible to store the suspension information at an optional position by assigning an address.

As explained above, according to the SIMD type processor relating to the present embodiment, it is possible to instantly suspend the processing and execute an interruption processing. With this arrangement, it is possible to efficiently carry out a parallel processing. Particularly when it takes time to process a job having a combination of a series of parallel processing and also when it is necessary to execute an interruption processing in consideration of the priority, the SIMD type processor becomes more convenient.

Further, as the SIMD type processor incorporates the program RAM, it is possible to instantly carry out an interruption processing without the need for loading the program from the outside. Further, as the program RAM can use necessary programs in combination, it is possible to use the SIMD type processor as a general-purpose processor or a programmable processor, with increased convenience.

Further, as the SIMD type processor incorporates the data RAM, it is possible to store and save the state of the interrupted job. With this arrangement, a superimposition of processing does not occur. When the interruption processing has been finished, it is possible to instantly restart the processing of the job suspended immediately before the interruption processing. As a result, it is possible to efficiently carry out the parallel processing.

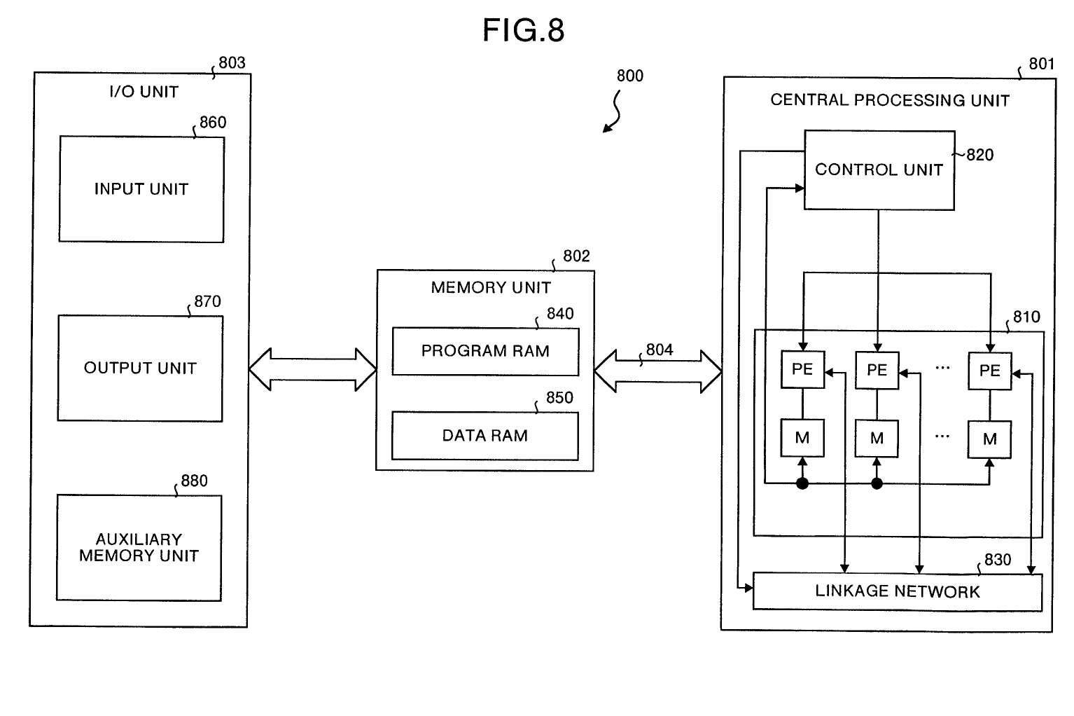

A parallel processing apparatus that efficiently carries out a parallel processing will be explained as a second embodiment. FIG. 8 is a diagram showing an example of a structure of a parallel processing apparatus relating to a second embodiment of the invention. A parallel processing apparatus 800 consists of a central processing unit 801 mainly for carrying out a processing, a memory unit 802 mainly for storing information, and an I/O unit 803 mainly for carrying out input/output operation with other units. A reference number 804 denotes a bus.

The central processing unit 801 consists of a SIMD type arithmetic processing section 810 for carrying out a parallel processing to given data, a linkage network 830 used for shifting a calculation result of the SIMD type arithmetic processing section 810 and for making the SIMD type arithmetic processing section 810 carry out a recalculation, and a control unit 820 for providing the SIMD type arithmetic processing section 810 with data to be processed and an instruction necessary for the SIMD type arithmetic processing section 810 to carry out a parallel processing, and for controlling the linkage network 830.

The memory unit 802 consists of a program RAM 840 that stores a program for making the central processing unit 801 execute a parallel processing, and a data RAM 850 that stores data for the parallel processing carried out by the central processing unit 801. The program RAM 840 and the data RAM 850 store not only a program and data for a parallel processing but also general data and a general program. In other words, these RAMs are general-purpose RAMs. By using the general-purpose RAMs, it is possible to construct the apparatus at low cost.

The I/O unit 803 consists of an input unit 860 like a keyboard and a mouse, an output unit 870 like a display and a printer, and an auxiliary memory unit 880 like an MO and a CD-R.

The SIMD type arithmetic processing section 810 consists of a plurality of equivalent processor elements PEs for carrying out an arithmetic processing, and a plurality of equivalent local memories for storing calculation results of the PEs. Each processor element PE consists of an ALU and a register in a similar manner to that of the first embodiment.

As is clear from FIG. 8, the parallel processing apparatus 800 has a structure to include all the constituent elements of the SIMD type processor 100 (reference FIG. 1) in the first embodiment. Therefore, the work effects of the present embodiment are common to those of the first embodiment. Other different work effects of the present embodiment will be explained below. While the SIMD type processor 100 has the program RAM 103 and the data RAM 104 inside the processor, the parallel processing apparatus 800 incorporates the program RAM 840 and the data RAM 850 in the memory unit 802. In other words, the position of installing the program RAM 840 and the data RAM 850 is not limited.

Based on the above-described structure, there occurs the following processing delay (a time lag). When the data and the instruction of the job 2 are loaded as the interruption processing of the first embodiment, from the outside of the central processing unit 801, that is, from the memory unit 802a, the processing delay occurs corresponding to the time required for this loading. However, the second embodiment has an advantage in that it is possible to secure a degree of freedom in designing the apparatus by a portion of the program RAM 840 and the data RAM 850 that need not be incorporated in the processor.

It is possible to minimize the occurrence of the time lag by efficiently managing the bus 804 for transferring the instruction and the data between the memory unit 802 and the central processing unit 801. In order to improve the processing efficiency, there may be provided in the bus 804 an exclusive bus to be used for the program RAM 840, the data RAM 850, and the central processing unit 801.

Whether the SIMD type processor 100 is to be used or the parallel processing apparatus 800 is to be used depends on the time lag that occurs, the degree of designing, and the processing contents. When the size of the data to be handled at one time is Giga-Byte to tera-byte, it is not practically possible to construct the SIMD type processor in one chip. In this case, the provision of the data RAM 850 at the outside of the central processing unit 801, as shown in FIG. 8, makes it possible to carry out an efficient parallel processing.

Further, as the data RAM 850 is a general-purpose RAM and as it is provided at the outside of the central processing unit 801, there is no practical constraint on the capacity of the data RAM 850. Therefore, in the case of executing a program having a possibility of an occurrence of many interruption requests, it is possible to store suspension information for many jobs in this data RAM. An efficient parallel processing can be carried out in this respect too.

Further, as is clear from FIG. 8, the control unit 820 can directly control the local memory M. Therefore, based on the combination with the linkage network 830, it is possible to carry out the following sequential processing. A result of a calculation carried out by the processor element PE is stored in the local memory M, and the control unit 820 reads all the contents of the local memory M. Next, the linkage network 830 is controlled to store the contents of the local memory M into the adjacent processor element PE.

Based on this, it can be considered that each processor element PE carries out a sequential processing by reflecting a result of the processing of other processor element PE, although in principle each processor element PE independently carries out the processing according to the parallel processing. Therefore, it is possible to carry out a sequential-processing type parallel processing by designing the programs of executing jobs. This linkage network may also be included in the SIMD type processor 100.

As explained above, according to the parallel processing apparatus relating to the present embodiment, it is possible to instantly suspend the processing and execute an interruption processing. With this arrangement, it is possible to efficiently carry out a parallel processing. When there is a large volume of data to be processed at one time, that is, when the data RAM and others cannot be incorporated into the processor, it is possible to provide a saving area at the outside to carry out an efficient processing.

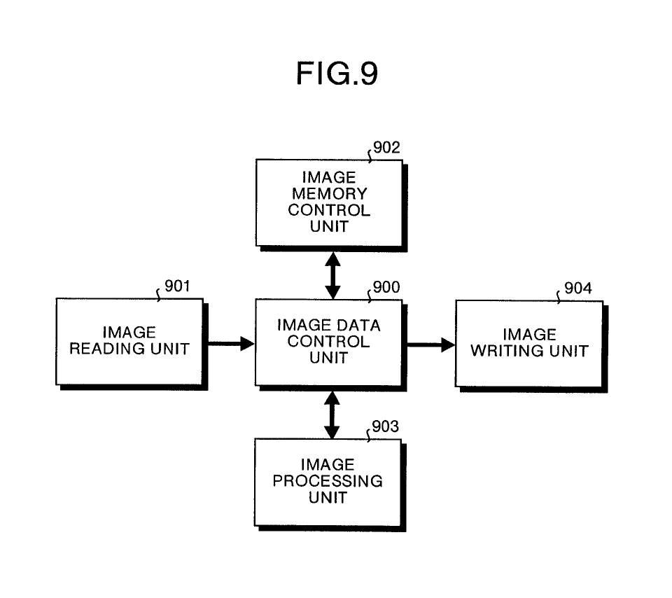

Next, an image processing apparatus equipped with the SIMD type processor of the first embodiment will be explained as a third embodiment of the invention. FIG. 9 is a functional block diagram showing a structure of an image processing apparatus relating to a third embodiment of the invention. In FIG. 9, the image processing apparatus consists of the following five units.

In other words, the image processing apparatus consists of an image data control unit 900, an image reading unit 901 for reading image data, an image memory control unit 902 for writing/reading image data by controlling an image memory for storing an image, an image processing unit 903 for carrying out an image processing like editing of the image data, and an image writing unit 904 for writing image data onto a transcription sheet.

With the image data control unit 900 at the center, the image reading unit 901, the image memory control unit 902, the image processing unit 903, and the image writing unit 904 are connected to the image data control unit 900 respectively. Depending on the using mode, a facsimile unit for carrying out a facsimile transmission/reception may be connected to the image data control unit 900.

The image data control unit 900 carries out the following kinds of processing, as an example.

(1) A data compression processing (a primary compression) for improving the data bus transfer efficiency.

(2) A transfer processing of transferring the primary compression data to image data.

(3) An image combine processing. (It is possible to combine image data from a plurality of units. This processing also includes a combining of image data on a data bus.)

(4) An image shift processing. (A shifting of an image to a main scanning direction and to a sub-scanning direction.)

(5) An image area expansion processing. (It is possible to expand an image area to the periphery by an optional volume.)

(6) An image multiplying processing. (For example, it is possible to multiply an image at a fixed rate of 50% or 200%.)

(7) A parallel bus interface processing.

(8) A serial bus interface processing. (An interface with a process controller 1011 to be described later.)

(9) A format conversion processing between a parallel data and a serial data.

(10) An interface processing of an interface with the image reading unit 901.

(11) An interface processing of an interface with the image processing unit 903.

The image combine processing in (3) above maybe carried out by the image processing unit 903.

The image reading unit 901 carries out the following kinds of processing, as an example.

(1) A read processing of a draft reflection beam by an optical system.

(2) A conversion processing for converting image data into an electric signal by a CCD (charge coupled device).

(3) A digitalization processing by an A/D converter.

(4) A shading correction processing (A processing for correcting a variance in the luminance distribution of a light source.)

(5) A scanner γ correction processing. (A processing for correcting density characteristics of a reading system.)

The shading correction processing in (4) and the scanner γ correction processing in (5) above may be carried out by the image processing unit 903.

The image memory control unit 902 carries out the following kinds of processing, as an example.

(1) An interface control processing for controlling an interface with the system controller.

(2) A parallel bus control processing. (An interface control processing for controlling an interface with a parallel bus.)

(3) A network control processing.

(4) A serial bus control processing. (A control processing of a plurality of external serial ports.)

(5) An internal bus interface control processing. (A command control processing with a console section.)

(6) A local bus control processing. (An access control processing of a ROM, a RAM and font data for starting the system controller.)

(7) A memory module operation control processing. (A write/read control processing of a memory module, etc.)

(8) An access control processing for controlling an access to the memory module. (A processing for arbitrating memory access requests from a plurality of units.)

(9) A data compression/expansion processing. (A processing for decreasing data volume for effective utilization of the memory.)

(10) An image edit processing. (A data clearance in a memory area, a rotation of image data, an image combining on the memory, etc.)

The data compression/expansion processing in (9) above may be carried out by the image processing unit 903.

The image processing unit 903 carries out the following kinds of processing, as an example.

(1) A shading correction processing. (A processing for correcting a variation in the luminance distribution of the light source.)

(2) A scanner γ correction processing. (A processing for correcting density characteristics of a reading system.)

(3) An MTF correction processing.

(4) A smoothing processing.

(5) An optional multiplying processing in a main scanning direction.

(6) A density conversion. (A γ conversion processing: corresponding to a density notch.)

(7) A simple multi-value processing.

(8) A simple binary processing.

(9) A random dither processing.

(10) A dither processing.

(11) A dot location phase control processing. (A right-hand lay dot, a left-hand lay dot.)

(12) An isolated point removal processing.

(13) An image area separation processing. (A color decision, an attribute decision, an adaptation processing.)

(14) A density conversion processing.

The image writing unit 904 carries out the following kinds of processing, as an example.

(1) An edge smoothing processing. (A jaggy correction processing.)

(2) A correction processing for relocating dots.

(3) A pulse control processing of an image signal.

(4) A format conversion processing between a parallel data and a serial data.

The edge smoothing processing in (1) above may be carried out by the image processing unit 903.

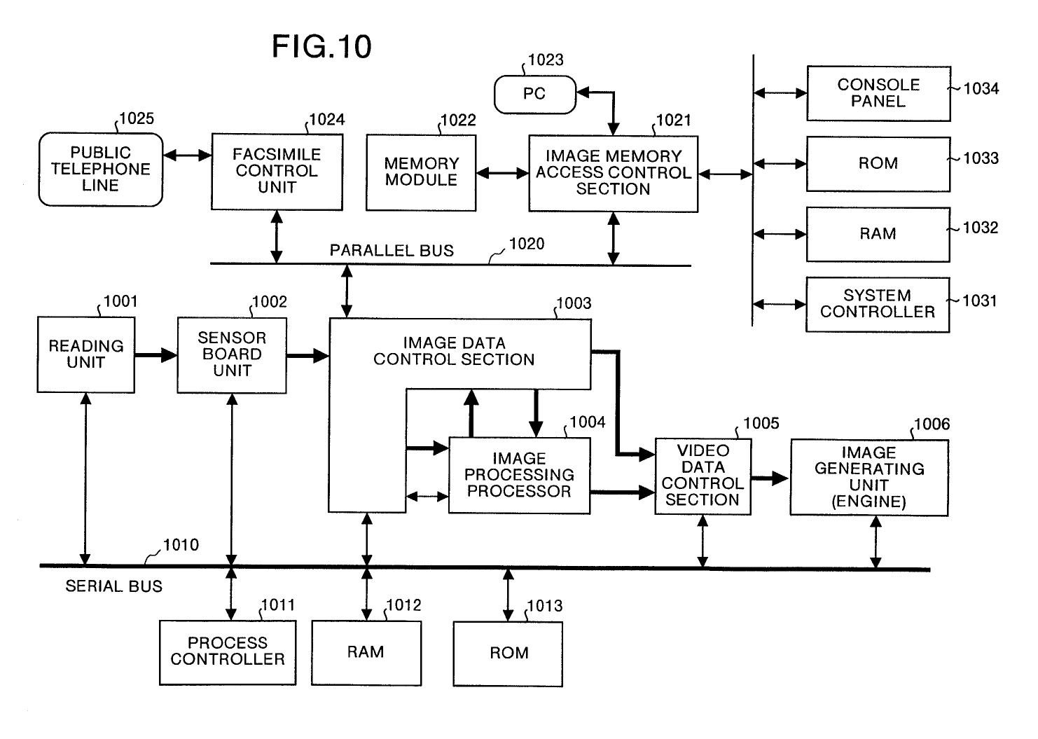

A hardware structure of a case where the image processing apparatus relating to the present embodiment structures a digital multi-functional apparatus will be explained next. FIG. 10 is a block diagram showing an example of a hardware structure of the image processing apparatus relating to the third embodiment.

In the block diagram shown in FIG. 10, the image processing apparatus relating to the present embodiment consists of a reading unit 1001, a sensor board unit 1002, an image data control section 1003, an image processing processor 1004, a video data control section 1005, and an image generating unit (an engine) 1006. Further, the image processing apparatus relating to the present embodiment includes a process controller 1011, a RAM 1012, and a ROM 1013 via a serial bus 1010.

Further, the image processing apparatus relating to the present embodiment includes an image memory access control section 1021, and a facsimile control unit 1024 via a parallel bus 1020. Further, the image processing apparatus includes a memory module 1022, a system controller 1031, a RAM 1032, a ROM 1033, and a console panel 1034 that are connected to the image memory access control section 1021 respectively.

A relationship between these units and the units 900 to 904 shown in FIG. 9 will be explained below. The reading unit 1001 and the sensor board unit 102 realize the function of the image reading unit 901 shown in FIG. 9. Similarly, the image data control section 1003 realizes the function of the image data control unit 900. Similarly, the image processing processor 1004 realizes the function of the image processing unit 903.

Further, similarly, the video data control section 1005 and the image generating unit (the engine) 1006 realize the image writing unit 904. Similarly, the image memory access control section 1021 and the memory module 1022 realize the image memory control unit 902.

The contents of each unit will be explained next. The reading unit 1001 for optically reading a draft consists of a lamp and a lens. The reading unit 1001 focuses a reflection beam of a lamp illumination light irradiated to the draft, onto a light receiving element by the mirror and the lens.

The light receiving element such as a CCD, for example, is mounted on the sensor board unit 1002. The CCD converts image data into an electric signal, and this is converted into a digital signal. Then, this digital signal is output (transmitted) from the sensor board unit 1002.

The image data output (transmitted) from the sensor board unit 1002 is input to (or received by) the image data control section 1003. The image data control section 1003 all controls the transmission of image data between the functional unit (processing unit) and the data bus.

The image data control section 1003 carries out a transfer of image data between the sensor board unit 1002, the parallel bus 1020, and the image processing processor 1004. Further, the image data control section 1003 carries out image data communications between the process controller 1011 and a system controller 1031 that carries out the total control of the image processing apparatus. The RAM 1012 is used as a work area of the process controller 1011, and the ROM 1013 stores a boot program and the like of the process controller 1011.

Further, the process controller 1011 transmits an interruption processing request to the image processing processor 1004 to be described later. The system controller 1031 may transmit this request, depending on the using mode. The RAM 1012 stores various kinds of programs relating to a parallel processing used by the image processing processor 1004, and transmits these programs to the image processing processor 1004 according to the need.

The image data output (transmitted) from the sensor board unit 1002 is transferred (transmitted) to the image processing processor 1004 via the image data control section 1003. The image processing processor 1004 corrects signal degradation (signal degradation of a scanner system) that occurred in the image data in the optical system and by the quantization of the data to a digital signal. The image processing processor 1004 outputs (transmits) the corrected signal to the image data control section 1003 again.

The image memory access control section 1021 controls the writing/reading of the image data to the memory module 1022. The image memory access control section 1021 also controls the operation of each unit connected to the parallel bus 1020. The RAM 1032 is used as a work area of the system controller 1031. The ROM 1033 stores a boot program and the like of the system controller 1031.

The console panel 1034 inputs the processing to be carried out by the image processing apparatus. For example, the console panel 1034 inputs a type of processing (such as a copying, a facsimile transmission, an image reading, a printing, etc.), and number of sheets to be processed. With this arrangement, it is possible to input image data control information. The contents of the facsimile control unit 1024 will be explained later.

The read image has two cases that the image data is stored in the memory module 1022 so that it is used at a later stage, and the image data is not stored in the memory module 1022. These jobs will be explained next. An example of storing the image data in the memory module 1022 is as follows. When one sheet of draft is to be copied onto a plurality of transcription sheets, the reading unit 1001 is operated only once, and the image data read by the reading unit 1001 is stored in the memory module 1022. Then, the stored image data is read out by the plurality of times to make copy.

An example of not using the memory module 1022 is as follows. When one sheet of draft is to be copied onto one transcription sheet, the read image data may be regenerated directly. Therefore, the image memory access control section 1021 does not need to make access to the memory module 1022.

First, in the case of not using the memory module 1022, the image data that has been transferred from the image processing processor 1004 to the image data control section 1003 is returned from the image data control section 1003 to the image processing processor 1004. The image processing processor 1004 carries out an image quality processing for converting the luminance data by the CCD in the sensor board unit 1002 into a signal of area gradation.

The image data after the image quality processing is transferred from the image processing processor 1004 to the video data control section 1005. The video data control section 1005 carries out a post processing of the dot location in the signal changed into the area gradation, and carries out a pulse control for regenerating the dots. Thereafter, the image generating unit 1006 forms a regenerated image onto a transcription sheet.

Next, an image data flow will be explained for storing the image data into the memory module 1022 and for carrying out an additional processing when reading the image data, such as, for example, a rotation of the image direction, a combining of images, etc. The image data that has been transferred from the image processing processor 1004 to the image data control section 1003, is then transmitted from the image data control section 1003 to the image memory access control section 1021 via the parallel bus 1020.

Based on the control of the system controller 1031, the image memory access control section 1021 controls the access of the image data and the memory module 1022, extends print data of an external PC (personal computer) 1023, and compresses/expands the image data for effective utilization of the memory module 1022.

The image data transmitted to the image memory access control section 1021 is stored in the memory module 1022 after the data compression. The stored image data is read out according to the need. The image data that has been read out is expanded, and is returned to the original image data. The image data is then returned from the image memory access control section 1021 to the image data control section 1003 via the parallel bus 1020.

After the image data has been transferred from the image data control section 1003 to the image processing processor 1004, the image processing processor 1004 carries out an image quality processing of the image data. Then, the video data control section 1005 carries out a pulse control of the image data. The image generating unit 1006 forms a regenerated image onto a transcription sheet.

In the image data flow, the function of the digital multi-functional apparatus is realized based on the bus control of the parallel bus 1020 and the image data control section 1003. The facsimile transmission function is as follows. The image processing processor 1004 image-processes the read image data, and transfers the processed image data to the facsimile control unit 1024 via the image data control section 1003 and the parallel bus 1020. The facsimile control unit 1024 then carries out a data conversion to the communication network, and transmits the converted data to a public telephone network (PN) 1025 as facsimile data.

On the other hand, a reception of facsimile data is carried out as follows. The facsimile control unit 1024 converts the line data from the public telephone network (PN) 1025 into image data. The converted image data is transferred to the image processing processor 1004 via the parallel bus 1020 and the image data control section 1003. In this case, no special image quality processing is carried out. The video data control section 1005 carries out a dot relocation and a pulse control, and the image generating unit 1006 forms a regenerated image onto a transcription sheet. When an image processing is necessary, the image processing processor 1004 suitably carries out the image processing.

When a plurality of jobs operate in parallel, the following job allocation is carried out. For example, when the copying function, the facsimile transmission/reception function, and the printer output function operate in parallel, the system controller 1031 and the process controller 1011 control the allocation of the using rights of the reading unit 1001, the image generating unit 1006, and the parallel bus 1020 to these jobs. When there is a job that requires the processing in the image processing processor 1004 among the allocated using rights, an interruption request signal is generated as described above. A decision is made as to whether the job currently being processed by the image processing processor 1004 is to be replaced by the job of this interruption request or not.

The process controller 1011 controls the flow of the image data, and the system controller 1031 controls the system as a whole and manages the starting of each resource. For selecting a function of the digital multi-functional apparatus, the console panel (console section) 1034 selectively inputs the function to set the processing contents such as, for example, the copying function, or the facsimile function, or the like.

The system controller 1031 and the process controller 1011 carry out mutual communications via the parallel bus 1020, the image data control section 1003, and the serial bus 1010. More specifically, the image data control section 1003 carries out a data format conversion for the data interface between the parallel bus 1020 and the serial bus 1010. Based on this, the communications between the system controller 1031 and the process controller 1011 are carried out.

(The image processing unit 903/image processing processor 1004)

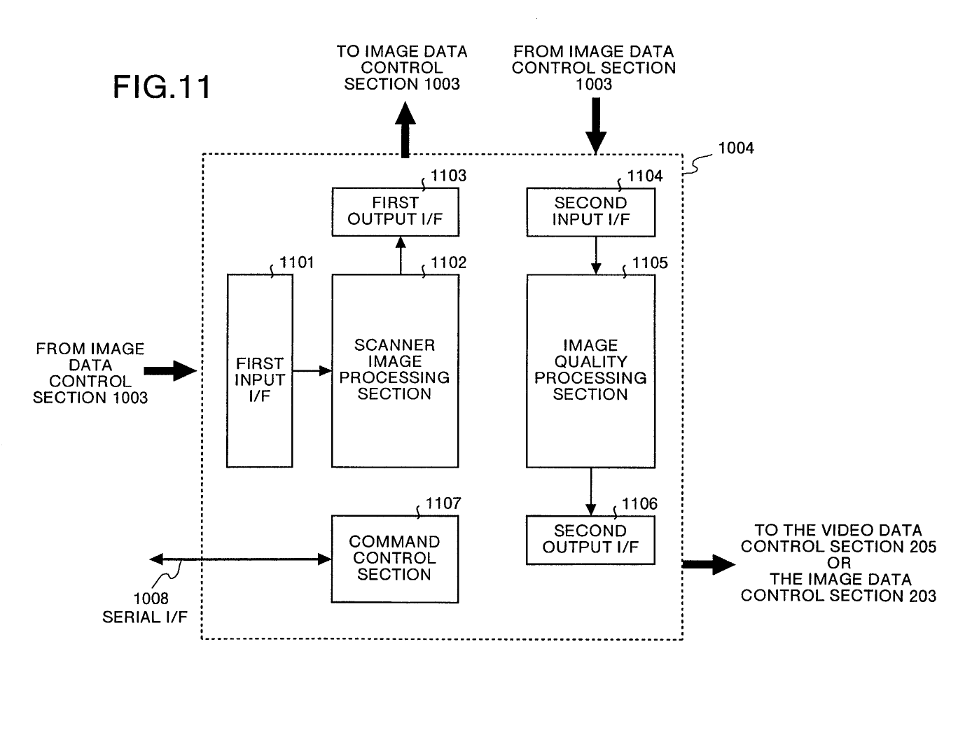

Next, the outline of the processing of the image processing processor 1004 that constitutes the image processing unit 903 will be explained. FIG. 11 is a functional block diagram showing the outline of the processing of the image processing processor 1004 of the image processing apparatus relating to the third embodiment.

In the block diagram shown in FIG. 11, the image processing processor 1004 includes a first input I/F 1101, a scanner image processing section 1102, a first output I/F 1103, a second input I/F 1104, an image processing section 1105, and a second output I/F 1106. While the scanner image processing section 1102 and the image processing section 1105 are shown separately in the drawing, these sections may not necessarily be provided separately but may be integrally structured by a SIMD type processing section as described later.

In the above structure, image data that has been read by the image reading unit 1001 is transferred from the first input interface (I/F) 1101 of the image processing processor 1004 to the scanner image processing section 1102 via the sensor board unit 1002 and the image data control section 1003. The scanner image processing section 1102 has an object of correcting the degradation of the read image data. Specifically, the scanner image processing section 1102 carries out a shading correction, a scanner γ correction, and an MTF correction. The scanner image processing section 1102 can also carry out a multiplexing processing of an expansion/compression of an image, although this is not a correction processing. After finishing the correction processing of the read image data, the scanner image processing section 1102 transfers the corrected image data to the image data control section 1003 via the first output interface (I/F) 1103.

For outputting the image data to a transcription sheet, the second input I/F 1104 receives the image data from the image data control section 1003, and the image processing section 1105 carries out an area gradation processing. After finishing the image processing of the image data, the image processing section 1105 outputs this image data to the video data control section 1005 or the image data control section 103 via the second output I/F 1106.

The area degradation processing of the image quality processing section 1105 includes a density conversion processing, a dither processing, and a random dither processing. The image quality processing section 1105 carries out an area approximation of gradation information as a main processing. Once the image data processed by the scanner image processing section 1102 has been stored in the memory module 1022, it is possible to confirm various regeneration images by changing the image quality by the image quality processing section 1105.

For example, it is possible to easily change the atmosphere of the regeneration image by changing the density of the regeneration image or by changing the number of lines of the dither matrix. In this case, it is not necessary to read the image data from the reading unit 1001 each time the processing is changed. Instead, the stored image data is read from the memory module 1022 so that it is possible to quickly carry out different kinds of processing many times.

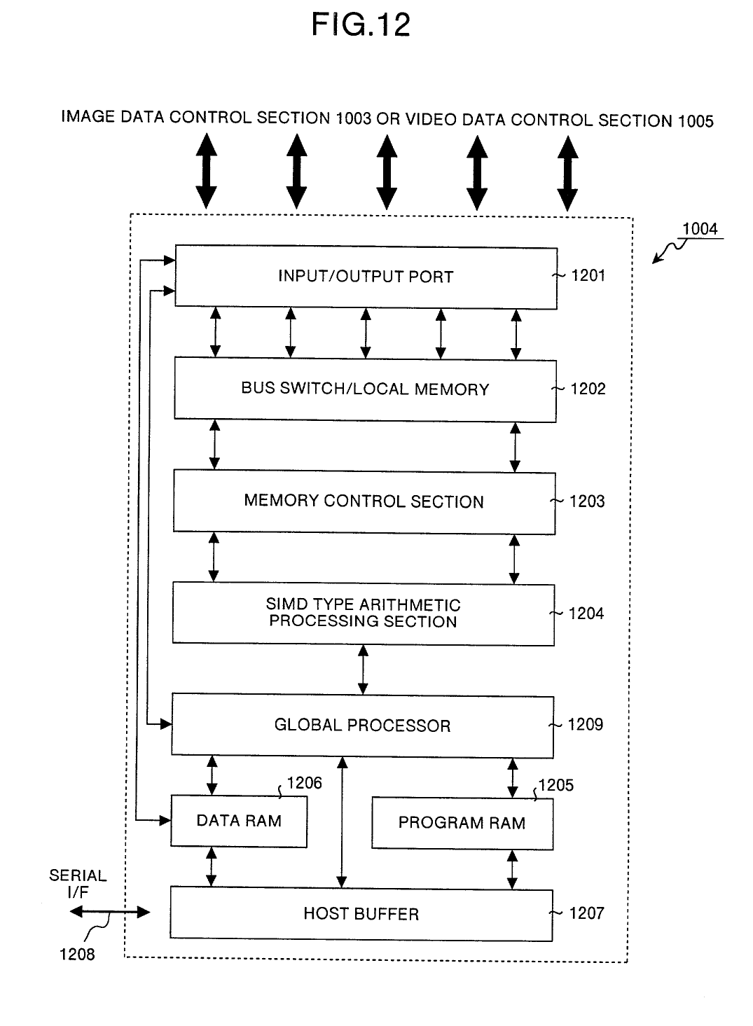

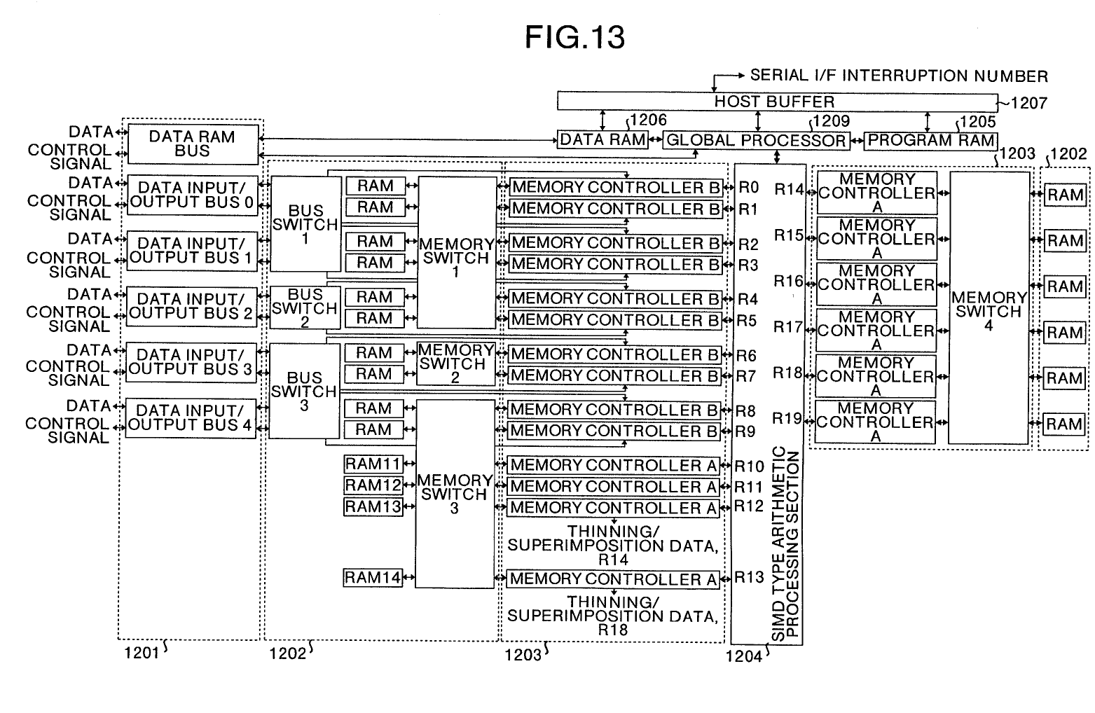

The internal structure of the image processing processor 1004 will be explained next. FIG. 12 is a block diagram showing an internal structure of the image processing processor 1004 of the image processing apparatus relating to the third embodiment, and FIG. 13 is a block diagram showing the details of FIG. 12. In the block diagram of FIG. 12, the image processing processor 1004 has a plurality of input/output ports (data input/output bus) 1201 for input/output of data and control signals to and from the outside. With this arrangement, the image processing processor 1004 can optionally set input and output of data.

Further, the image processing processor 1004 also has a bus switch/local memory group 1202 connected to the input/output ports 1201. A memory control section 1203 controls a memory area and a path of a data bus to be used. The bus switch/local memory group 1202 is allocated as buffer memories to the input data and the data to be output, thereby to save these data in the allocated buffer memories. Thus, the interface with the outside is controlled. This bus switch/local memory group 1202 corresponds to the data register group 107 in the first embodiment.

A SIMD type arithmetic processing section 1204 carries out various kinds of processing to the image data stored in the bus switch/local memory group 1202, and stores an output result (that is, processed imaged data) into the bus switch/local memory group 1202 again.

Contents of parameter data of a program RAM 1205 and a data RAM 1206 are downloaded from the process controller 1011 to a host buffer 1207 via a serial I/F 1208. The serial I/F 1208 is the same as the serial I/F 1108 shown in FIG. 11. The data RAM 1206 is also connected to the input/output ports 1201 in order to input in advance the data necessary for an interruption processing, for example, line data. The process controller 1011 reads a program counter value within a global processor 1209 to understand the process of the processing.

When it becomes necessary to change the contents of the processing or to change the processing mode required by the system, the contents of the program RAM 1205 and the data RAM 1206 that are referred to by the SIMD type arithmetic processing section 1204 are updated. Parameter data is input from the RAM 1012 via the serial I/F 1208, and data to be processed is input from the image data control section 1003 via the input/output ports 1201.

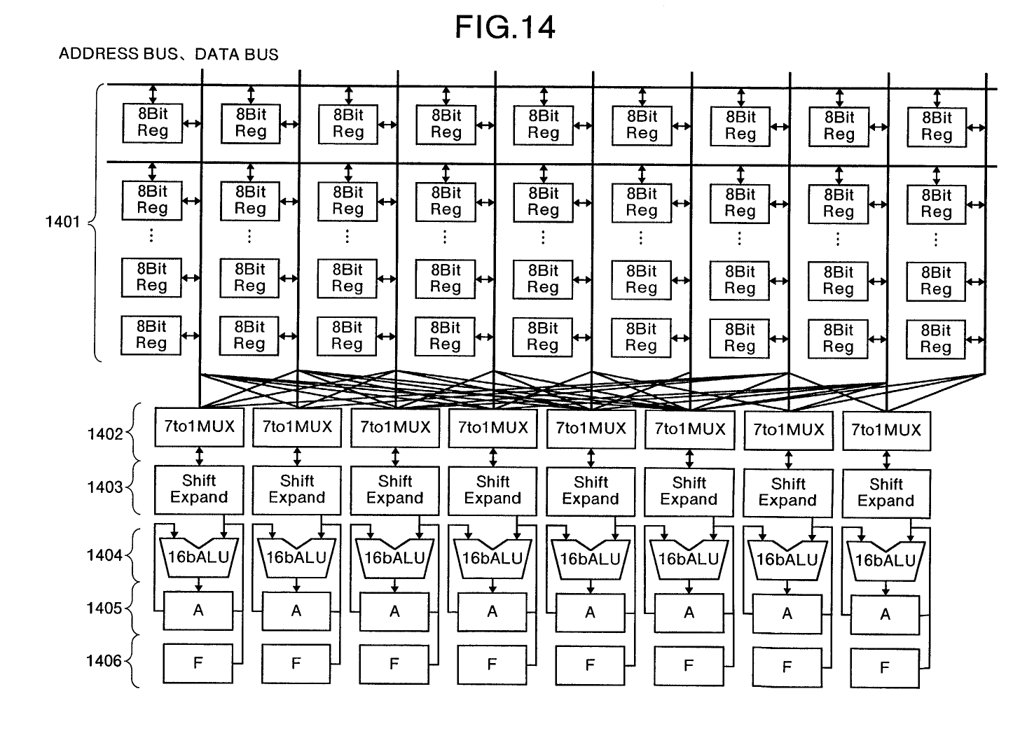

FIG. 14 is an explanatory diagram showing the outline structure of the SIMD type arithmetic processing section 1204. As explained in the first embodiment, the SIMD is for making a plurality of data executed in parallel by using a single instruction, and is constructed of a plurality of PEs (processor elements).

Each PE consists of a register (Reg) 1401 for storing data, a multiplexer (MUX) 1402 for making access to the register of other PE, a barrel shifter (Shit Expand) 1403, an ALU 1404, an accumulator (A) 1405 for storing a logic result, and a temporary register (F) 1406 for temporarily saving the contents of the accumulator 1405. The Reg 1401 corresponds to the data registers R0 to Rn in FIG. 1. As is clear from FIG. 13, n=19. The MUX 1402 plays the same role as that of the linkage network 830 shown in FIG. 8.

Each register 1401 is connected to an address bus and a data bus (a lead line and a word line), and stores an instruction code that prescribes a processing, and data to be processed. The contents of the register 1401 are input to the ALU 1404, and a result of the arithmetic processing is stored in the accumulator 1405. For taking out the processing result from the PE, the result is temporarily saved in the temporary register 1406. A processing result of data is obtained by taking out the contents from the temporary register 1406. The global processor 1209 controls the taking out of this processing result.

Although eight PEs are shown in FIG. 14, there may be provided 224 PEs when the reading unit 1001 reads the image data as one line 224 pixels, for example. When the image data of each pixel is located in the register 1401 and also when the PEs arithmetically process all the pixels using the same one instruction code, it is possible to obtain a processing result of one line in a shorter time than when the pixels are sequentially processed one by one. Particularly, all the PEs can carry out the space filter processing and the shading correction processing by using an arithmetic processing expression using a common instruction code.

The same contents of the instruction code are given to all the PEs, and the data to be processed are different for each PE. The multiplexer 1402 makes reference to the contents of the register 1401 of the adjacent PE when necessary. The results of the parallel processing are output to the respective accumulators 1405. In general, the parallel arithmetic processing is not good at a processing of the sequential arithmetic processing, for example, a calculation by reflecting a processing result of two pixels before into a focused pixel. However, this problem can be solved when the register 1401 is combined with the MUX 1402.

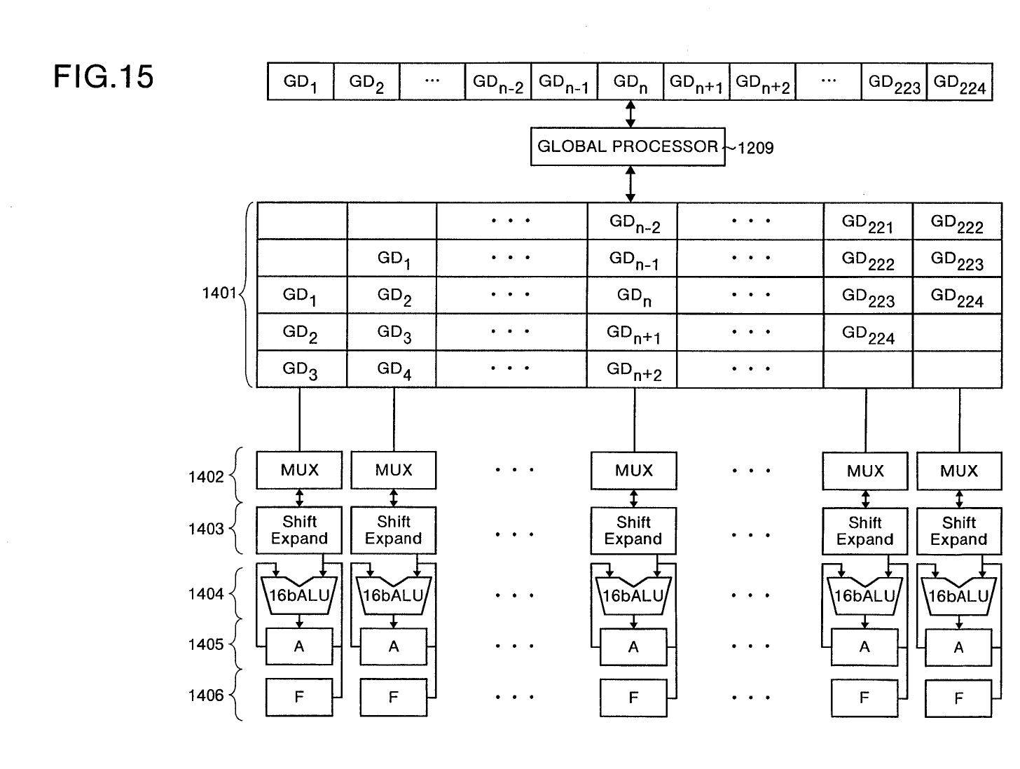

FIG. 15 is an explanatory diagram for explaining a method of storing in a register capable of carrying out a sequential processing. GD represents pixel data. Assume that in a processing of n-th pixel, it is necessary to refer to each two pixels before and after this n-th pixel. In this case, under the control of the global processor 1209, five copies are delivered to the register 1401 by shifting storage positions as shown in the drawing. With this layout, a sequential processing can be carried out by parallel processing according to a program. For reflecting a calculation result to the next pixel, the MUX 1402 shifts the result to store it in the register 1401.

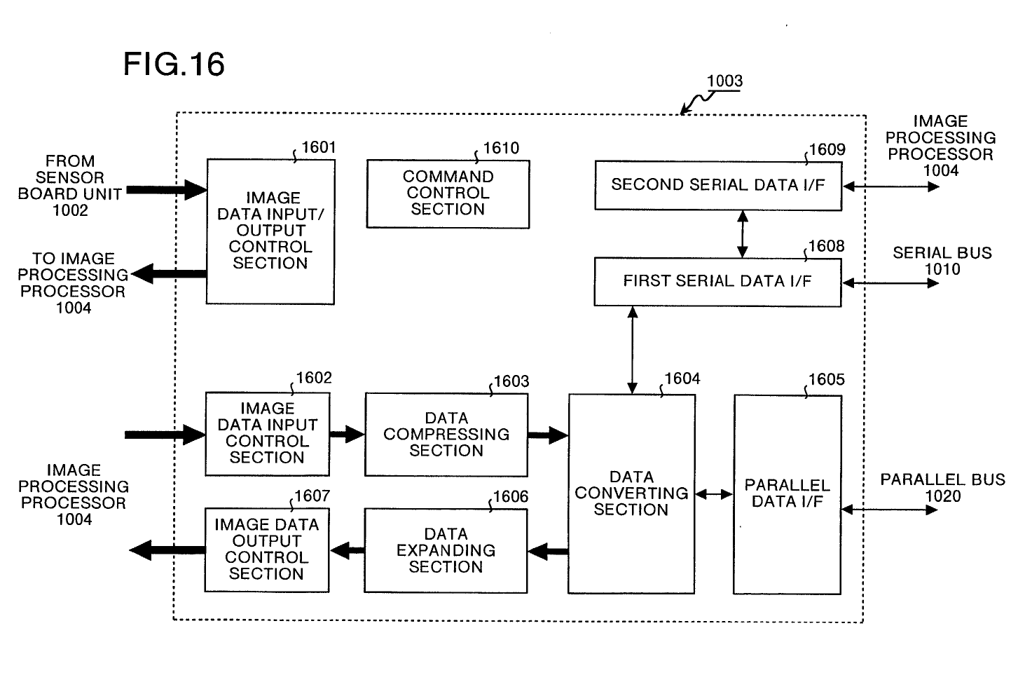

The outline of the processing of the image data control section 1003 that constitutes the image data control unit 900 will be explained next. FIG. 16 is a block diagram showing the outline of the processing of the image data control section 1003 of the image processing apparatus relating to the third embodiment.

Referring to the block diagram shown in FIG. 16, an image data input/output control section 1601 inputs (receives) image data from the sensor board unit 1002, and outputs (transmits) image data to the image processing processor 1004. In other words, the image data input/output control section 1601 is a structure element for connecting between the image reading unit 901 and the image processing unit 903 (the image processing processor 1004). The image data input/output control section 1601 is an exclusive input/output section for only transmitting the image data read by the image reading unit 901 to the image processing unit 903.

An image data input control section 1602 inputs (receives) image data that has been scanner-image corrected by the image processing processor 1004. In order to increase the transmission efficiency of the input image data in the parallel bus 1020, a data compressing section 1603 compresses the data. Then, the compressed image data is passed through a data conversion section 1604 and is transmitted to the parallel bus 1020 via a parallel I/F 1605.

As the image data input from the parallel bus 1020 via the parallel data I/F 1605 has been compressed for the purpose of the bus transfer, the compressed imaged data is transmitted to a data expanding section 1606 via the data conversion section 1604. The data expanding section 1606 expands the data. The expanded image data is transferred from an image data output control section 1607 to the image processing processor 1004.

The image data control section 1003 also has a data conversion function for converting data between the parallel data and the serial data. The system controller 1031 transfers data to the parallel bus 1020, and the process controller 1011 transfers data to the serial bus 1010. The image data control section 1003 carries out the data conversion for the communications between the two controllers.

The serial data I/F has a first serial data I/F 1608 for exchanging data with the process controller via the serial bus 1010, and a second serial data I/F 1609 for exchanging data with the image processing processor 1004. By having one independent set of I/Fs between the image data control section 1003 and the image processing processor 1004, it is possible to smooth the interface with the image processing processor 1004.

A command control section 1610 controls the operation of each constituent element and each interface within the image data control section 1003, based on the input instruction.

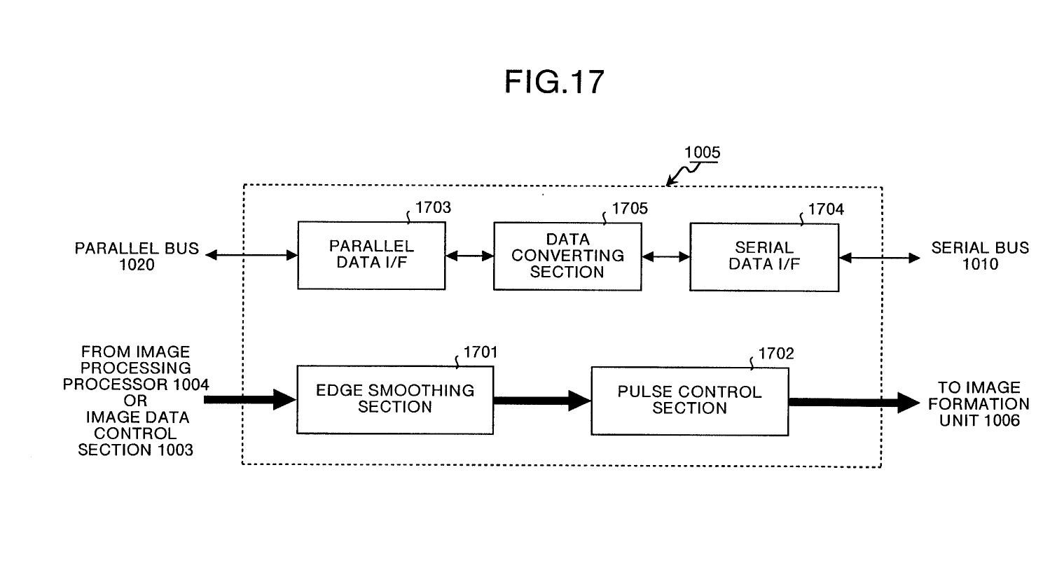

Next, the outline of the processing of the video data control section 1005 that constitutes a part of the image writing unit 904 will be explained. FIG. 17 is a block diagram showing the outline of the processing of the video data control section 1005 of the image processing apparatus relating to the third embodiment.

In the block diagram shown in FIG. 17, the video data control section 1005 carries out an add processing to the input image according to the characteristics of the image generating unit 1006. Specifically, an edge smoothing processing section 1701 relocates dots by an edge smoothing processing, and a pulse control section 1702 carries out a pulse control of an image data for forming the dots. The image data that has been subjected to the above processing is input to the image generating unit 1006.

Separate from the image data conversion, the video data control section 1005 has a format conversion function for converting a data format between the parallel data and the serial data. Based on this function, the video data control section 1005 can communicate by itself with the system controller 1031 and the process controller 1011. Specifically, the video data control section 1005 has a parallel data I/F 1703 capable of transmitting/receiving parallel data, a serial data I/F 1704 capable of transmitting/receiving serial data, and a data conversion section 1705 for converting data received by the parallel data I/F 1703 into serial data and data received by the serial data I/F 1704 into parallel data. Thus, the data control section 1005 can convert both data formats.

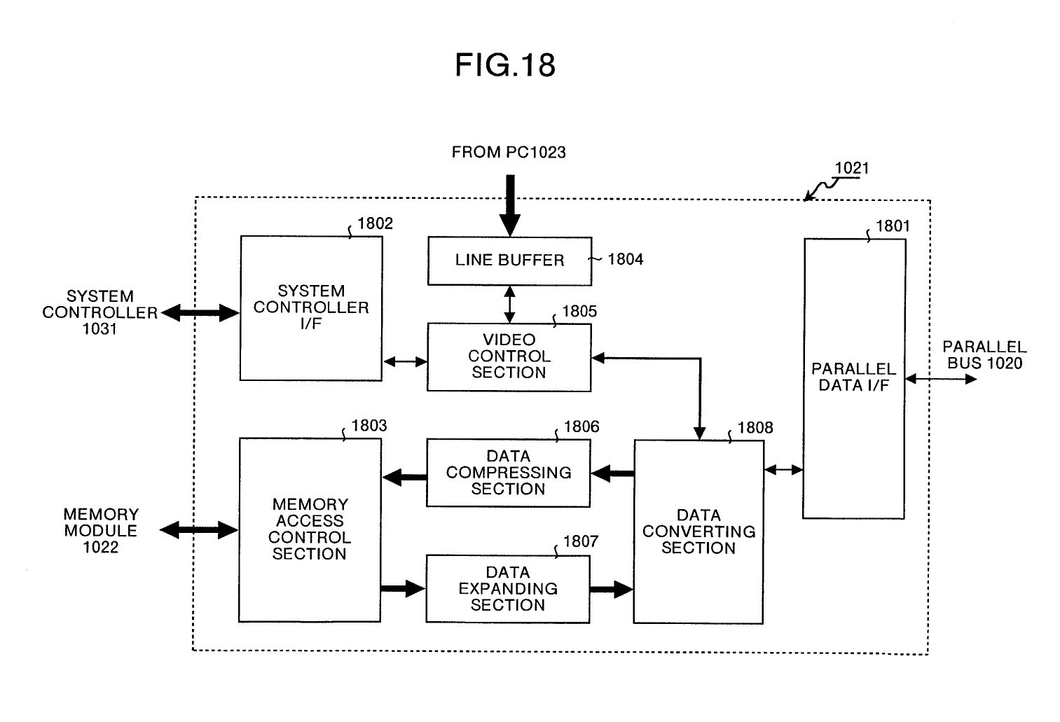

Next, the outline of the processing of the image memory access control section 1021 that constitutes a part of the image memory control unit 902 will be explained. FIG. 18 is a block diagram showing the outline of the processing of the image memory access control section 1021 of the image processing apparatus relating to the third embodiment.

In the block diagram of FIG. 18, the image memory access control section 1021 manages the interface of image data with the parallel bus 1020, and controls the access of the image data, that is, the storing (writing)/reading of the image data, to the memory module 1022. The image memory-access control section 1021 also controls the expansion of coded data mainly input from an external PC 1023 into image data.

For this purpose, the image memory access control section 1021 includes a parallel data I/F 1801, a system controller I/F 1802, a memory access control section 1803, a line buffer 1804, a video control section 1805, a data compressing section 1806, a data expanding section 1807, and a data conversion section 1808.

The parallel data I/F 1801 manages the interface of image data with the parallel bus 1020. The memory access control section 1803 controls the access of the image data, that is, the storing (writing) /reading of the image data, to the memory module 1022.

The line buffer 1804 stores the input coded data in a local area. The video control section 1805 expands the coded data stored in the line buffer 1804 into image data based on a expansion processing instruction input from the system controller 1031 via the system controller I/F 1802.

The expanded image data or the image data is input from the parallel bus 1020 via the parallel data I/F 1801, and is stored in the memory module 1022. In this case, the data conversion section 1808 selects the image data to be stored, and the data compressing section 1806 compresses the data in order to increase the memory-using rate. Then, the memory access control section 1803 stores (writes) the image data into the memory module 1022 by managing the address of the memory module 1022.

The memory access control section 1803 controls the reading destination address of the image data stored (accumulated) in the memory module 1022, and the data expanding section 1807 expands the image data that has been read out. For transferring the expanded image data to the parallel bus 1020, the data is transferred via the parallel data I/F 1801.

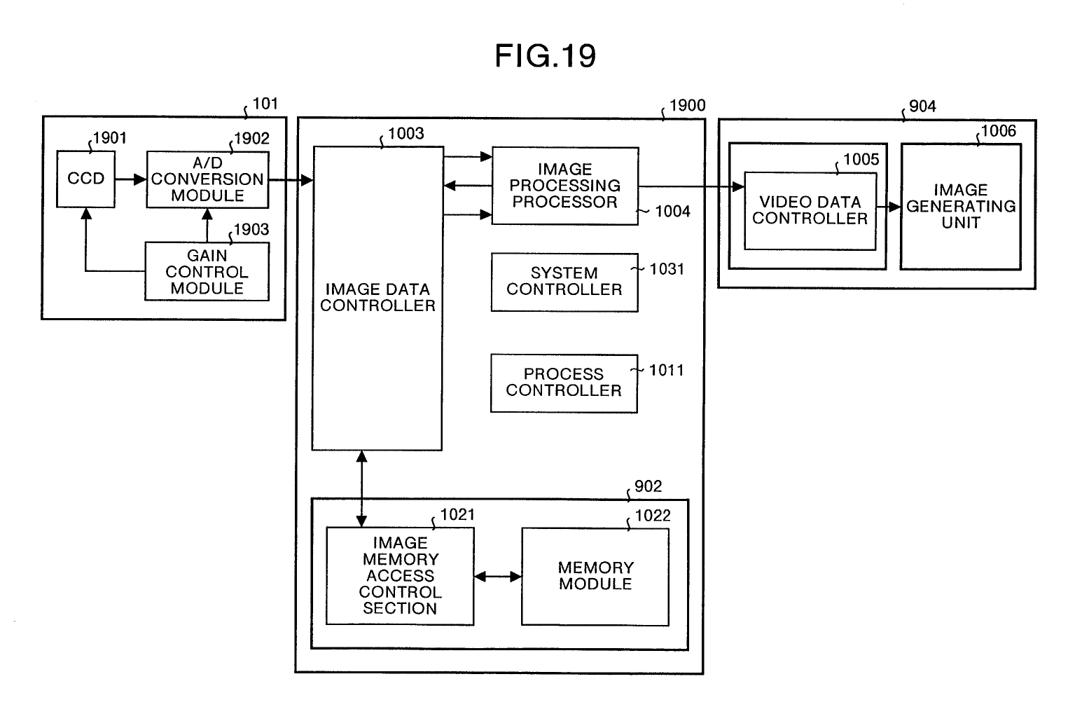

Next, unit structures of the image processing apparatus relating to the present embodiment will be explained. FIG. 19 is a block diagram showing an example of unit structures when the image processing apparatus is a digital multi-functional apparatus.

In the case of a digital multi-functional apparatus as shown in FIG. 19, the apparatus consists of three units including an image reading unit 901, an image engine control unit 1900, and an image writing unit 904. An independent PCB can manage each unit.

The image reading unit 901 consists of a CCD 1901, an A/D conversion module 1902, and a gain control module 1903. Based on this structure, the image reading unit 901 converts optical image information that has been optically read, into a digital image signal.

The image engine control unit 1900 mainly consists of a system controller 1031, a process controller 1011, and a memory module 1022 within an image memory control unit 902. The image engine control unit 1900 collectively handles an image processing processor 1004, an image memory access control section 1021, and an image data control section 1003 for carrying out a bus control.

An image writing unit 904 has a structure of a video data control section 1005 as a main, including an image generating unit 1006.

Based on these unit structures, when the specifications and performance of the image reading unit 901 have been changed, it is necessary to change only the image reading unit 901 in the system of the digital multi-functional apparatus. As the data interface has been held, it is not necessary to change other units. When the image generating unit (engine) 1006 has been changed, it is possible to reconstruct the system by only changing the image writing unit 904.

As the units that depend on the input/output devices construct the system by separate structures, it is possible to upgrade the system by a minimum exchange of units so long as the data interface has been held.

In the structure of the image engine control unit 1900 shown in FIG. 19, the modules (constituent elements) of the image processing processor 1004, the image data control section 1003, and the image memory access control section 1021 are structured by independent modules. Therefore, the image engine control unit 1900 is used as the controller by using common modules as general-purpose modules and by deleting unnecessary modules. As explained above, the module for the image engine control and the module for the controller are not prepared separately, and a common module is used to achieve similar functions.

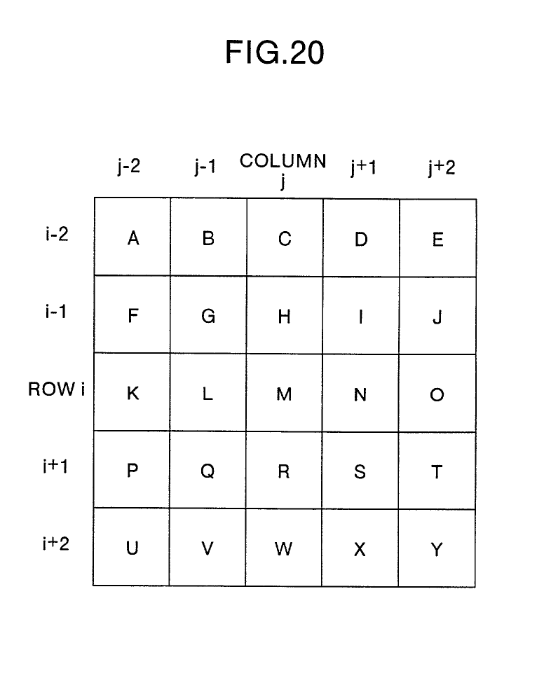

Next, the contents of the image processing of the image processing apparatus relating to the present embodiment will be explained. FIG. 20 is an explanatory diagram showing the outline of a scanner (an example of a space filter) of the image processing apparatus relating to the third embodiment. The MTF correction function is realized by the structure of the space filter.

In FIG. 20, when a two-dimensional space filter is structured by involving filter coefficients from A to Y, all the input image data is filtered based on the same arithmetic processing. For example, in the case of carrying out a space filter processing around the input image data (a row i, and a column j), the image of the row i and the column j is arithmetically processed based on a corresponding coefficient. A pixel of (i, j) is processed using a coefficient value M, and a pixel of (i, j+1) is processed using a coefficient value N. A calculation result within a filter matrix is output as a processing result of a focused pixel (i, j).

When a focused pixel is (i, j+1), the pixel of (i, j+1) is arithmetically processed using the coefficient value M, and when a focused pixel is (i, j+2), the pixel of (i, j+2) is arithmetically processed using the coefficient value N. A calculation result within a filter matrix is output as a processing result of the focused pixel (i, j+1).

The input image data are different, and the parameter used for the processing is common. In this space filter processing, the values of the coefficients A to Y are not fixed, but the values can be set optionally according to the characteristics of the input image and the desired image quality. When the values of the coefficients cannot be changed, the flexibility of the image processing function may not be secured.

For carrying out this processing by the image processing processor 1004, the coefficient values are downloaded by the process controller 1011. When the structure of the reading unit has been changed and also when the degradation characteristics of the read image have been changed, the contents of the data tobe loaded can be changed. Thus, it is possible to cope with the change of the system.

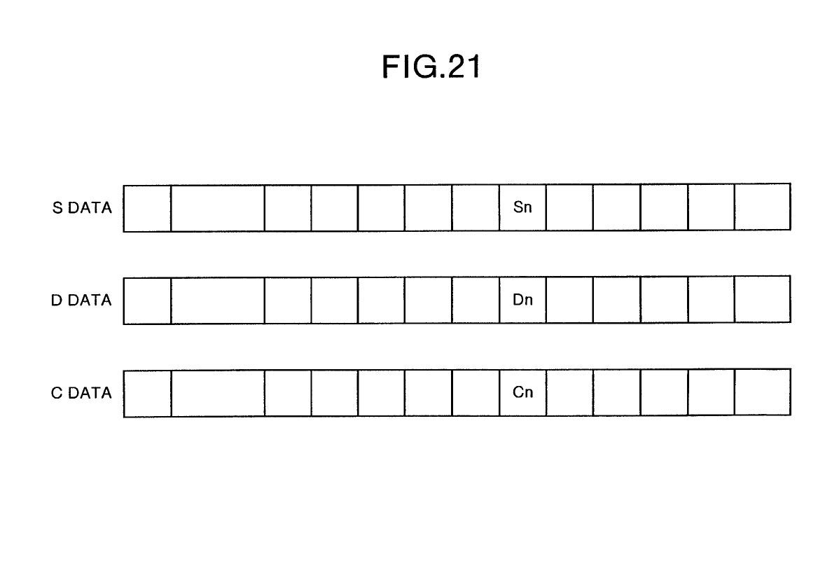

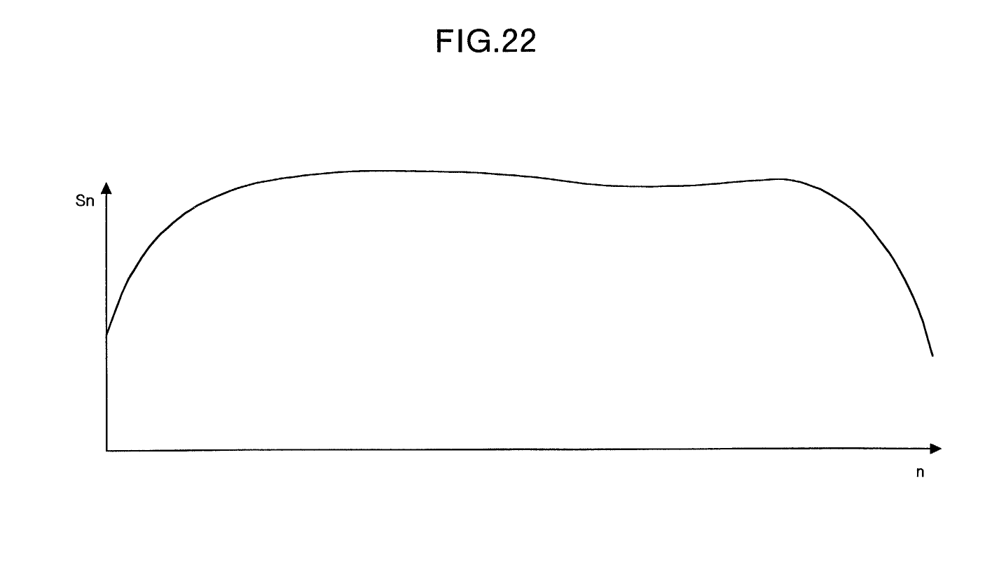

FIG. 21 is an explanatory diagram showing the outline of a shading correction of the image processing apparatus relating to the third embodiment, and FIG. 22 is an explanatory diagram showing the outline of shading data of the image processing apparatus relating to the third embodiment. The shading correction is a correction of in homogeneity of reflection light characteristics based on the luminance distribution of the illumination system. Prior to the reading of a draft, a reference white board of homogeneous density is read to generate reference data for the shading correction. Based on this shading data, the reflection distribution depending on a reading position of a read image is normalized.

As shown in FIG. 22, the reflection distribution of the shading data is different depending on a draft reading position n. At the end portion of the draft reading position, the white board of the homogenous density is read as dark. Sn represents a white board reading signal level at the reading position n. When Sn is larger, this means that the draft has been read as bright.

The shading correction corrects a variation in the light quantity distribution of a lamp by carrying out the same processing to each read image that depends on a position. S data shown in FIG. 21 represents shading data generated based on the reading of the white board shown in FIG. 22. D data shown in FIG. 21 represents read image data read of each reading line. A character n represents a reading position.

C data is data after shading correcting the D data, and this is normalized by the following expression:

Cn=A×(Dn/Sn)

where A represents a normalization coefficient.

The image processing processor 1004 stores the S data in the local memory, and carries out the correction processing of the input D data between the corresponding Dn and Sn.

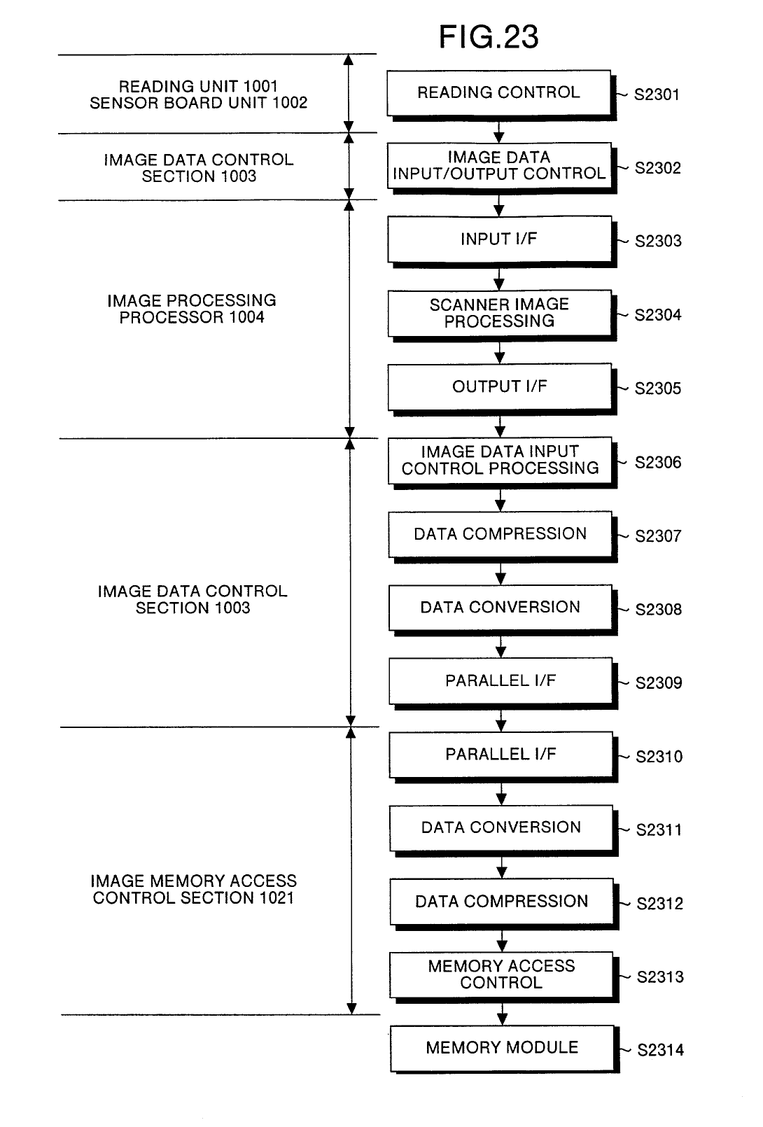

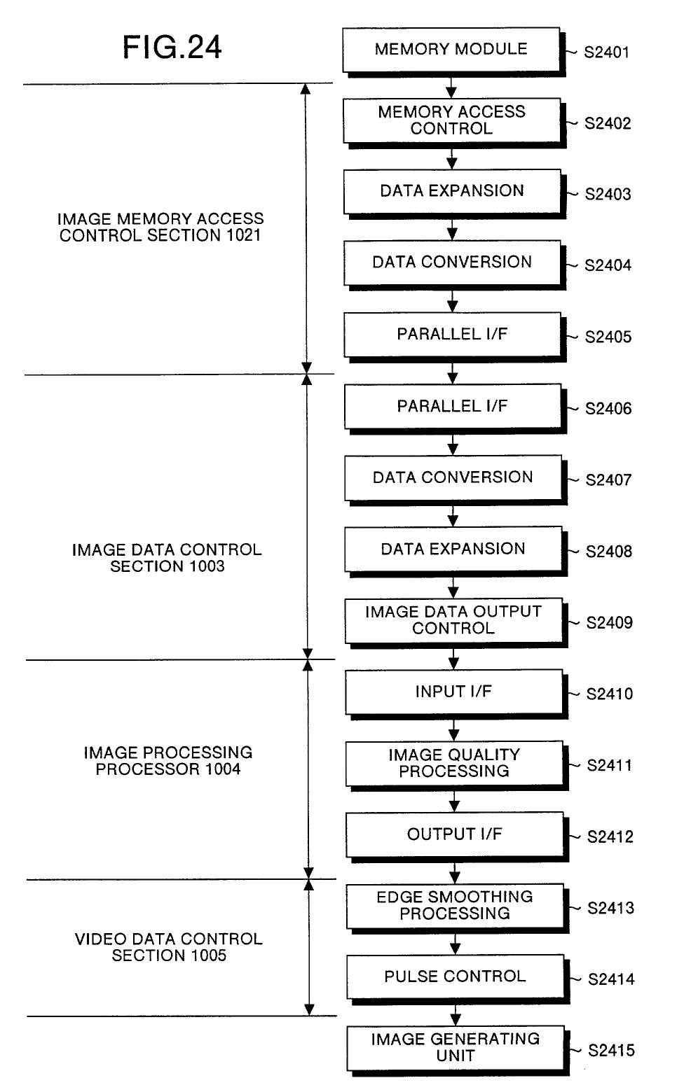

A processing of storing an image into the memory module 1022 will be explained next. FIG. 23 and FIG. 24 are explanatory diagrams showing a data flow of an image processing apparatus as a digital multi-functional apparatus involving an image storing processing for storing an image into the memory module 1022 relating to the third embodiment.

FIG. 23 shows a flow from the reading unit 1001 to the memory module 1022, and FIG. 24 shows a flow from the memory module 1022 to the image generating unit 1006. The image data control section 1003 carries out each processing by controlling the data flow between the bus and the unit.

Referring to FIG. 23, the reading unit 1001 and the sensor board unit 1002 carry out a read control (step S2301). Next, the image data control section 1003 carries out an input processing and an output processing of the image data (step S2302). Next, the image processing processor 1004 carries out an input I/F control processing (step S2303), the scanner image processing (step S2304), and the output I/F processing (step S2305).

Next, the image data control section 1003 carries out an input processing of the image data (step S2306), a data compression (step S2307), a data conversion (step S2308), and a parallel I/F control processing (step S2309).

Next, the image memory access control section 1021 carries out a parallel I/F control processing (step S2310), a data conversion (step S2311), a data compression (step S2312), and a memory access control to the memory module 1022 (step S2313). Thus, the image data is stored into the memory module 1022 (step S2314).

Next, referring to FIG. 24, the image memory access control section 1021 carries out a memory access control (step S2402) to the image data stored in the memory module 1022 (step S2401). Then, the image memory access control section 1021 carries out a data expansion (step S2403), a data conversion (step S2404), and a parallel I/F control processing (step S2405).

Next, the image data control section 1003 carries out a parallel I/F control processing (step S2406), a data conversion (step S2407), a data expansion (step S2408), and an image data output control (step S2409).

Next, the image processing processor 1004 carries out an input I/F control processing (step S2410), an image quality processing (step S2411), and an output I/F control processing (step S2412).

Next, the video data control section 1005 carries out an edge smoothing processing (step S2413), and a pulse control (step S2414). Thereafter, the image generating unit 1006 carries out an image generating processing (step S2415).

A scanner image processing unit of the image processing processor 1004 can independently carry out a scanning of the read image data, and the image processing processor 1004 can independently carry out an image quality processing of the image data to be output to the image generating unit 1006.

The scanner image processing and the image quality processing can be operated in parallel. The read image can be facsimile transmitted, and in parallel, the image data stored in advance in the memory module 1022 can be output to a transcription sheet while changing the contents of the image quality processing.

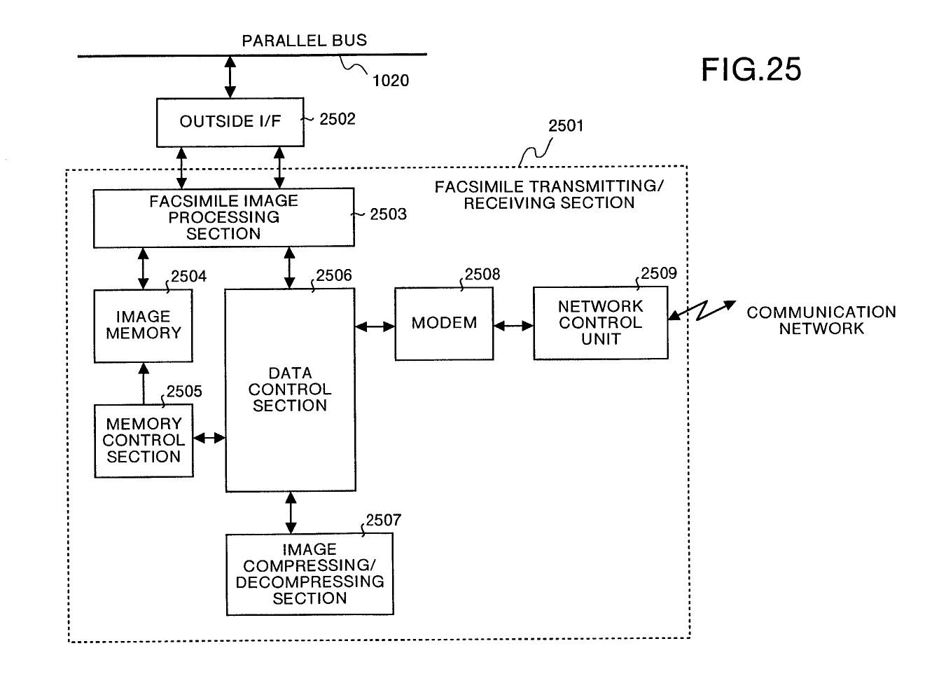

A functional structure of the facsimile control unit 1024 will be explained next. FIG. 25 is block diagram showing a structure of the facsimile control unit 1024 of the image processing apparatus relating to the third embodiment.

Referring to the block diagram shown in FIG. 25, the facsimile control unit 1024 consists of a facsimile transmitting/receiving section 2501, and an external I/F 2502. The facsimile transmitting/receiving section 2501 converts image data into data of a communication format, and transmits the data to an external line. Also, the facsimile transmitting/receiving section 2501 converts the data received from the outside into image data, and passes the data through the external I/F 2502 and the parallel bus 1020 to the image generating unit so that the image generating unit records and outputs the image.

The facsimile transmitting/receiving section 2502 consists of a facsimile processing section 2503, an image memory 2504, a memory control section 2505, a data control section 2506, an image compressing/expanding section 2507, a modem 2508, and a network control unit 2509.

The edge smoothing processing section 1701 within the video data control section 1005 shown in FIG. 17 carries out a binary smoothing processing of the received image for the facsimile image processing. Further, the image memory access control section 1021 and the memory module 1022 carry out a part of the output buffer function of the image memory 2504.

For starting a transmission of the image data in the facsimile transmitting/receiving section 2501 having the above-described structure, the data control section 2506 instructs the memory control section 2505 to sequentially read the stored image data from the image memory 2504. The facsimile processing section 2503 restores the read image data into the original signal, converts the density of the image data, and multiplies the image data. The data is added to the data control section 2506.

The image compressing/expanding section 2507 code compresses the image data added to the data control section 2506, modulates the image data by the modem 2508, and then transmits this data to a destination via the network control unit 2509. The image information of which transmission has been completed is deleted from the image memory 2504.

When the image data has been received, the received image is once stored in the image memory 2504. When it is possible to record output the received image, the image is record output at a point of time when the reception of an image for one sheet has been completed. When the reception has been started during a copying operation by a call, the received image is stored in the image memory 2504 until when the using rate of the image memory 2504 reaches, for example, 80%. When the using rate of the image memory 2504 has reached 80%, the writing operation that is being executed at that time is forcedly suspended, and the received image is read out from the image memory 2504 for record out.

In this case, the received image data that has been read from the image memory 2504 is deleted from the image memory 2504. When the using rate of the image memory 2504 has been lowered to a predetermined value, such as, for example, 10%, the suspended writing operation is restarted. The remaining received image is record output at a point of time when this writing operation has been all finished. In order to make it possible to restart the writing after once suspending the writing operation, various parameters for the writing operation are saved inside. These parameters are internally restored at the restarting time.

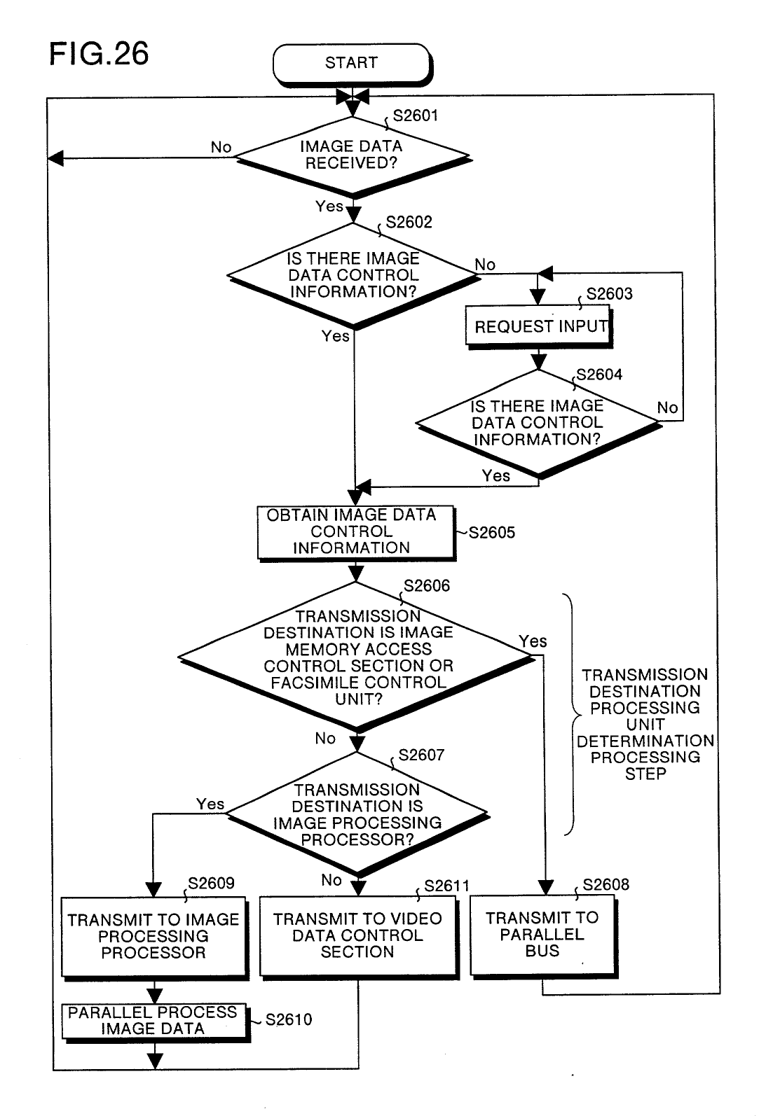

Next, the contents of a series of processing of an image processing method relating to the present embodiment will be explained. FIG. 26 is a flowchart showing a procedure of a series of processing in an image processing method relating to the third embodiment.

In the flowchart shown in FIG. 26, the image data control section 1003 first makes a decision as to whether image data has been received from the other constituent element (unit) or not (step S2601). When image data has been received after waiting for the reception of the image data (YES at step S2601), the image data control section 1003 next makes a decision as to whether there is image data control information relating to the received image data or not (step S2602).

The image data control information is the information relating to what kind of processing (control) is to be carried out for the received image data. In the case of the kinds of the processing (the copying, the facsimile transmission, the image reading, the printing, etc.) described above and the printing, the number of sheets for the processing is stored. Usually, the operator inputs the image data control information. However, when there is no such input operation, it is also possible to make a decision like “there is image data control information” based on the own characteristics of the image data like the kind of the image data.

When there is no image data control information at step S2602 (step S2602), an input request for image data control information is made (step S2603). The console panel 1034 may make display of a message to ask the operator to input the image data control information.

Thereafter, the image data control section 1003 makes a decision as to whether there has been an input of image data control information from the operator (for example, the depression of a console button of the console panel 1034) or not (step S2604). When there has been no input of image data control information (NO at step S2604), the process proceeds to step S2603. Then, the input request is made continuously until when there has been an input of image data control information. When there has been an input of image data control information, the process proceeds to step S2605.

At step S2605, the image data control information is obtained. Thereafter, based on the obtained image data control information, the image data control section 1003 makes a decision as to whether the transmission originator of the received image data is the image memory access control section 1021 or the facsimile control unit 1024 or not (step S2606).

At step S2606 when the transmission originator of the received image data is the image memory access control section 1021 or the facsimile control unit 1024 (YES at step S2606), the image data control section 1003 transmits the image data to the parallel bus 1020 (step S2608). Thereafter, the process proceeds to step S2601, and the image data control section 1003 waits for a reception of new image data.

On the other hand, when the transmission originator of the received image data is other than the image memory access control section 1021 or the facsimile control unit 1024 (NO at step S2606), the image data control section 1003 makes a decision as to whether the transmission originator of the received image data is the image processing processor 1004 or not (step S2607).

When the transmission originator of the received image data is the image processing processor 1004 at step S2607, (YES at step S2607), the image data control section 1003 transmits the image data to the image processing processor 1004 (step S2609). The SIMD type arithmetic processing section 1204 parallel processes the transmitted image data (step S2610). Thereafter, the process proceeds to step S2601, and the image data control section 1003 waits for a reception of new image data.

On the other hand, when the transmission originator of the received image data is not the image processing processor 1004 at step S2607, (NO at step S2607), the image data control section 1003 makes a decision that the image data is the data to be written, and transmits the image data to the video data control section 1005 (step S2611) Thereafter, the process proceeds to step S2601, and the image data control section 1003 waits for a reception of new image data. The image data control section 1003 repeats the transmission and reception processing of the image data in the manner as described above.

In the present embodiment, the case of applying the SIMD type processor to the image processing processor 1004 has been mainly explained. However, the application of the SIMD type processor is not limited to only the image processing. It is also possible to apply the SIMD type processor to various functional units, such as, the image reading unit 901, the image data control unit 900, the image writing unit 904, the image memory control unit 902, and the facsimile control unit 1024.

Next a unit structure divided by function will be explained.

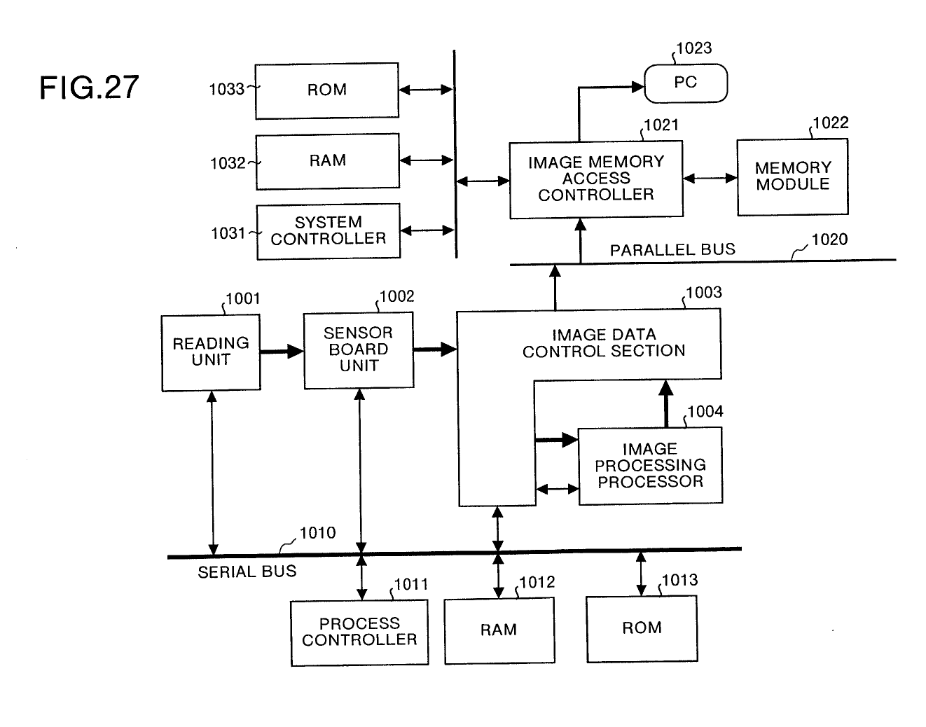

A hardware structure when the image processing apparatus relating to the present embodiment constitutes a single scanner will be explained. FIG. 27 is a block diagram showing another example of a hardware structure of the image processing apparatus relating to the third embodiment. Constituent elements similar to those in the block diagram of the hardware structure shown in FIG. 10 are attached with identical reference numbers, and their explanation will be omitted.

The hardware system structure of the single scanner shown in FIG. 27 is largely different from that of the digital multi-functional apparatus shown in FIG. 10 in that the single scanner has no image generating unit 1006. As the image generating unit is not necessary, the video data control section 1005 is not loaded either.

Image data that has been read by the image reading unit 1001 is digitally converted by the sensor board unit 1002, and is then transferred to the image processing processor 1004 via the image data control section 1003. Thereafter, the image processing processor 1004 carries out the image processing requested as a single scanner.

While the correction of the degradation of the read image is a main image processing required for the single scanner, it is also possible to carry out a gradation processing suitable for a display unit using a screen. Therefore, there are many types of processing different from the image quality processing that uses transcription sheets.

When the image processing processor 1004 is constructed of a programmable arithmetic processing apparatus (for example, the SIMD type processor 100 or the parallel processing apparatus 800), it is sufficient to set only a processing procedure that is necessary for the image quality processing to the transcription sheets and the gradation processing to the screen. It is not necessary to have both the image quality processing procedure and the gradation processing procedure all the time.

Image data after the gradation processing is transferred to the image data control section 1003, and is then transmitted to the image memory access control section 1021 via the parallel bus 1020. The scanner function is realized when the memory module 1022 is used as a buffer memory, and the image data is transferred to the driver attached to the PC 1023.

Like the digital multi-functional apparatus, this apparatus also manages the image data and the system resources using the system controller 1031 and the process controller 1011.

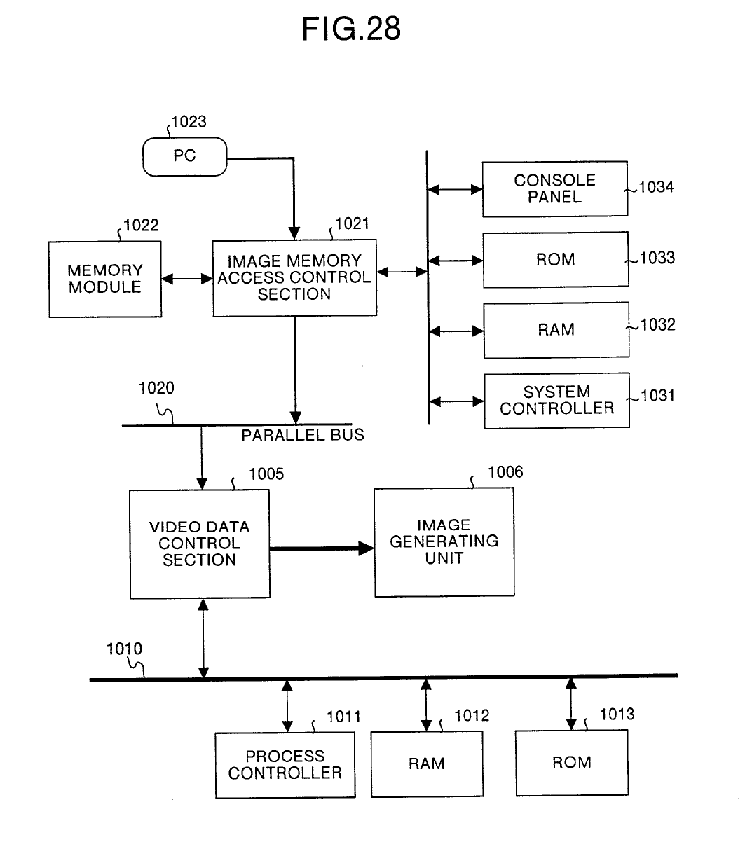

A hardware structure when the image processing apparatus relating to the present embodiment constitutes a single printer will be explained. FIG. 28 is a block diagram showing another example of a hardware structure of the image processing apparatus relating to the third embodiment. Constituent elements similar to those in the block diagram of the hardware structure shown in FIG. 10 are attached with identical reference numbers, and their explanation will be omitted.

The hardware system structure of the single printer shown in FIG. 28 is largely different from that of the digital multi-functional apparatus shown in FIG. 10 in that the single printer has no reading unit 1001. As it is not necessary to read an image, the sensor board unit 1002 and the image processing processor 1004 are not loaded either. As the image data is directly linked from the parallel bus 1020 to the video data control section 1005, the image data control section 1003 is not necessary either. In this case, the SIMD type processor may be used for the video data control section 1005. For example, the edge smoothing processing section 1701 may be used.

The image memory access control section 1021 inputs the image data (coded data) for print outputting from the PC 1023. Based on the control of the system controller 1031, the image memory access control section 1021 expands the coded image into image data. The memory module 1022 is used as the memory of the expansion destination.

Next, the image data is read from the memory module 1022, and is then transferred to the video data control section 1005 via the parallel bus 1020. The video data control section 1005 relocates the dots, and controls the pulse. The image generating unit 1006 forms a regenerated image onto a transcription sheet.

The system controller 1031 expands the image data, and the process controller 1011 outputs the image data. The data format conversion between the parallel data and the serial data for communications between the system controller 1031 and the process controller 1011 maybe carried out within the video data control section 1005.

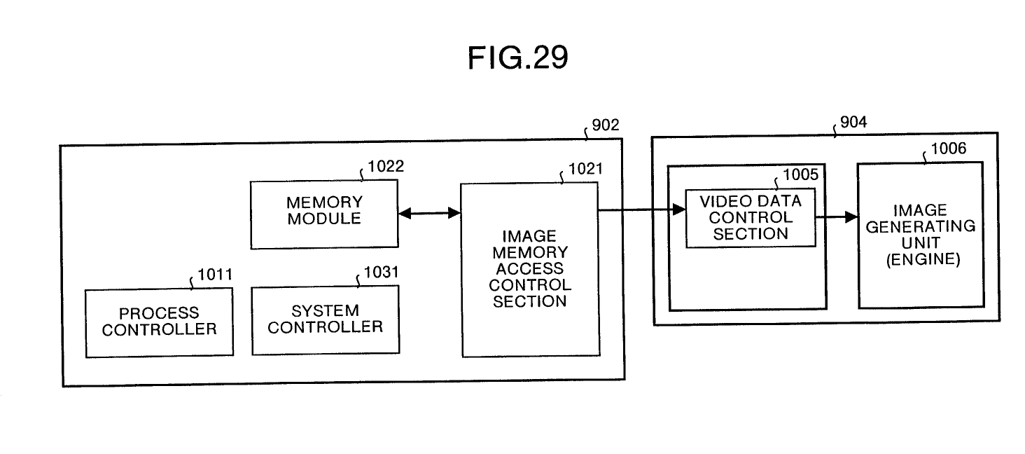

FIG. 29 shows an example of a structure of an apparatus as a single printer. When the image generating unit (engine) 1006 same as that of the digital multi-functional apparatus is used in the single printer, it is possible to share the image writing unit 904 with a digital copier.

When the image processing apparatus is used as a single printer, the image reading unit 901 is not necessary, and the image reading unit 901 is removed from the system structure of the digital multi-functional apparatus. The image engine control unit 1900 can be made common to that of the digital multi-functional apparatus to achieve the function. However, this becomes over-specification. Further, as the image processing processor 1004 is not necessary, it is possible to structure a controller optimum for the system by using a separate board, which leads to optimization of cost.

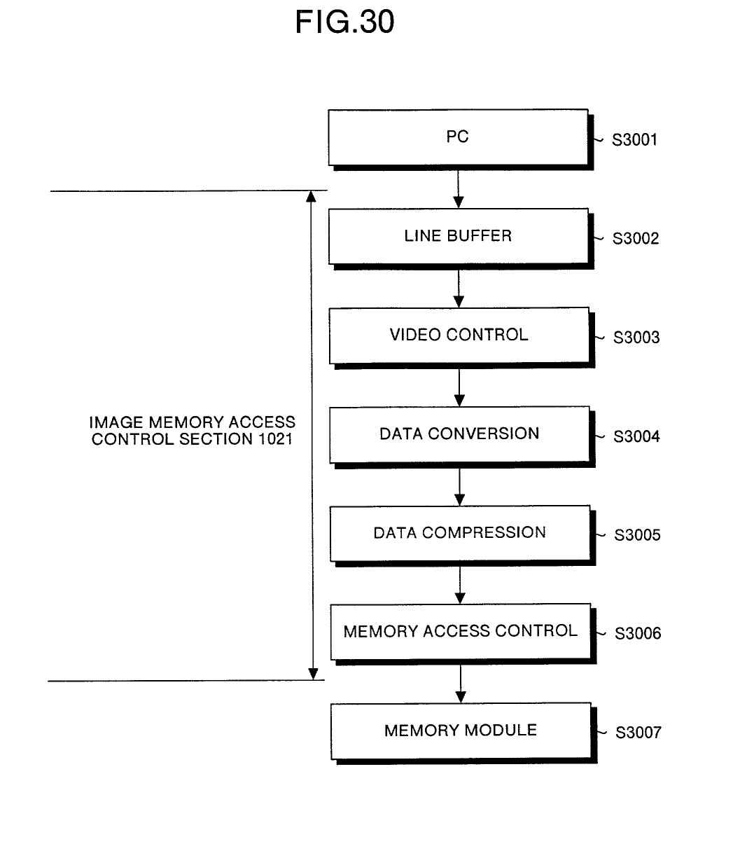

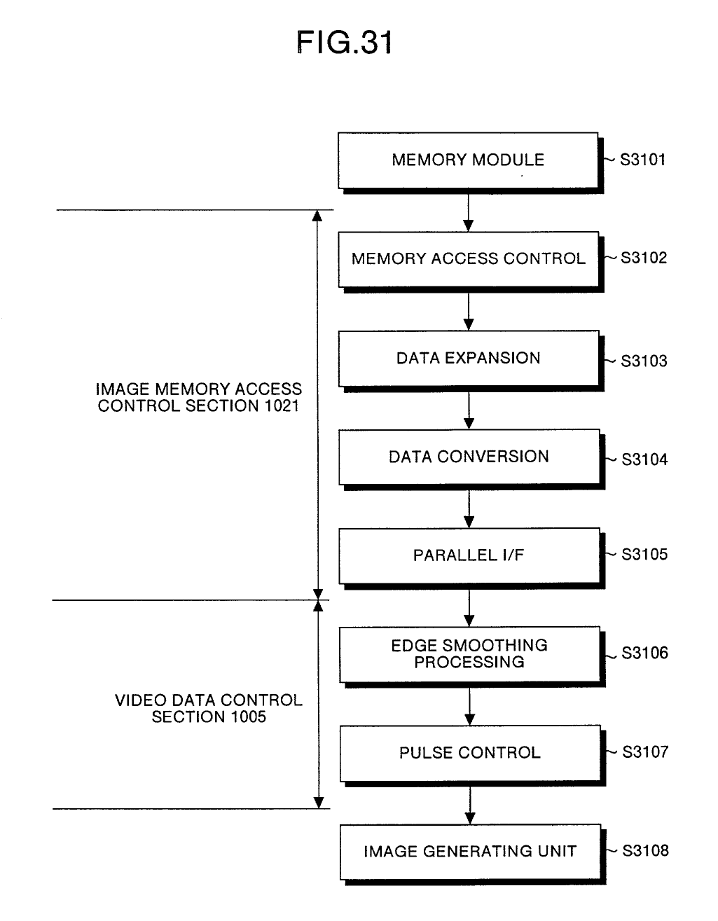

FIG. 30 and FIG. 31 are explanatory diagrams showing a data flow of an image processing apparatus as a single printer involving an image storing processing for storing an image into the memory module 1022 relating to the third embodiment. FIG. 30 shows a data flow from the PC 1023 to the memory module 1022, and FIG. 31 shows a data flow from the memory module 1022 to the image generating unit 1006.

In FIG. 30, the PC 1023 outputs image data (step S3001), and the image memory access control section 1021 holds the image data by the line buffer (step S3002), controls the video (step S3003), converts the data (step S3004), and compresses the data (step S3005). Then, the image memory access control section 1021 carries out a memory access control to the memory module 1022 (step S3006). Thus, the image data is stored in the memory module 1022.

In FIG. 31, the image memory access control section 1021 carries out a memory access control (step S3102) to the image data stored in the memory module 1022 (steps S3101) Then, the image memory access control section 1021 carries out a data expansion (step S3103), a data conversion (step S3104), and a parallel I/F control processing (step S3105).

Next, the video data control section 1005 carries out an edge smoothing processing (step S3106), and a pulse control (step S3107). Thereafter, the image generating unit 1006 carries out an image generating processing (step S3108)

When the coded data from the PC 1023 is converted into image data, and is then once stored in the memory module 1022, the data expansion is carried out only once for making a plurality of print outputs. Therefore, the print performance can be improved from that of the controller that expands the image data each time.

Further, by changing the contents of the post-processing of the video data control section 1005, the image data read from the memory module 1022 can be formed as reproduced images of a plurality of variations onto transcription sheets for the same image. Further, it is also possible to process the image data at high speed using the SIMD type processor 100. It is not necessary to expand the coded data into the image data each time when the parameters of the edge smoothing processing and the pulse control processing of the video data control section 1005 are changed.

As explained above, according to the image processing apparatus relating to the present embodiment, it is possible to optimize the processing performance of the image data using the SIMD type processor. As a result, it is possible to effectively utilize the resources of the system for realizing the multi-function, which makes it possible to carry out an optimum control for the system as a whole.

Further, according to the image processing apparatus relating to the present embodiment, it is possible to effectively utilize the image memory, and it is also possible to optimize the processing of the stored image. Thus, it is possible to control the adaptation of the image memory control to the input/output devices. Further, it is possible to optimize the image processing of the image data, and to control the adaptation of the image processing to the input/output devices.

Further, by changing the program, it is possible to easily cope with the changes in the system specifications, and the addition of functions. Further, as the image processing unit is constructed of the SIMD type processor, it is possible to process the image based on a high-speed arithmetic processing.

Further, it is possible to effectively utilize the image memory in the transmission/reception of facsimile images.

Further, the image reading unit and/or the image data control unit and/or the image memory control unit and/or the image processing unit and/or the image writing unit an/or the facsimile control unit are structured as independent units respectively. Therefore, is it possible to easily divide the manufacture of devices that have similar processing systems like the MFP, the single scanner, the single printer, etc., and it is possible to construct a multi-function system at low cost.

Further, as the image data control information is input, it is possible to optimize the processing performance of the image data based on the input image data control information. Further, it is possible to easily update the image processing algorithm and the parameters for the image processing. Thus, it is possible to follow the system with only minimum changes in the units when the processor and data transmission performances are different. It is possible to effectively utilize the memory in a plurality of functional operations. As a result, the designers can easily design the improvement in the functions of the digital multi-functional apparatus. Further, the users of the digital multi-functional apparatus can receive the provision of the latest algorithm.

The image processing method explained in the present embodiment can be realized by executing the program prepared in advance, by the personal computer and the computer of a workstation. This program is recorded onto a computer-readable recording medium such as a hard disk, a floppy disk, a CD-ROM, an MO, a DVD, etc., and is executed by being read from the recording medium by the computer. This program can be distributed via the network like the Internet via the above recording medium.

As explained above, according to the present invention, there is provided a SIMD type processor in which each units carry out the following processing. The parallel processing unit carries out a parallel processing using a plurality of arithmetic units which carry out an arithmetic processing to given data. The data providing unit provides data to be arithmetically processed to the parallel processing unit. Instruction providing unit provides the same instruction for carrying out the arithmetic processing to each of the arithmetic unit. The input unit inputs an interruption request for carrying out other parallel processing by interrupting a parallel processing currently carried out by the parallel processing unit. The decision unit makes a decision as to whether a parallel processing requested by the interruption request input from the input unit is to be carried out or not. The suspending unit suspends a parallel processing currently being carried out by the parallel processing unit when the decision unit has decided that the interruption processing is to be carried out. The control unit controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units. Therefore, it is possible to execute the interruption processing by instantly suspending the processing. As a result, there is an effect that it is possible to obtain a SIMD type processor capable of efficiently carrying out a parallel processing.

Further, the SIMD type processor further includes an instruction storing unit that stores the instruction. Therefore, it is possible to instantly execute the parallel processing including the interruption processing, without loading from the outside of the processor the instruction necessary for the parallel processing including the interruption processing. As a result, there is an effect that it is possible to obtain a SIMD type processor capable of efficiently carrying out a parallel processing.

Further, in the SIMD type processor, the storing unit stores suspension information consisting of data and an instruction at a point of time when a parallel processing has been suspended by the suspending unit, the detecting unit detects whether the interruption processing has been finished or not, the transmission unit transmits the suspension information stored by the storing unit to an original position when the detecting unit has detected a finish of the interruption processing. Therefore, it is possible to instantly store a state of the suspended processing into the processor and to instantly restore the state of the suspended processing. As a result, there is an effect that it is possible to obtain a SIMD type processor capable of efficiently carrying out a parallel processing.

Further, the SIMD type processor further includes a program counter, and an accumulator that is used in the arithmetic units. The program counter assigns an instruction stored by the instruction storing unit, and each arithmetic units carries out the arithmetic processing using the accumulator. Therefore, it is possible to carry out a processing of what is called one-address system, which makes it possible to shorten the length of the instruction. As a result, there is an effect that it is possible to obtain a SIMD type processor capable of efficiently carrying out a parallel processing.

Further, the SIMD type processor further includes an accumulator and a resistor that are used in the arithmetic units; and a data register that stores data provided by the data providing unit. The suspension information consists of a program counter value, contents of the accumulator and the register, and data stored in the data register, at a point of time when a parallel processing has been suspended by the suspending unit. Therefore, it is possible to restore a state of the processor to a state at a point of time when the processing has been suspended, without decoding from the beginning the processing instructions that have been used for the parallel processing when this processing has been suspended. As a result, there is an effect that it is possible to obtain a SIMD type processor capable of efficiently carrying out a parallel processing.

Further, in the SIMD type processor, the storing unit stores various parameter data that are necessary for the arithmetic processing carried out by the arithmetic units. Therefore, it is possible to simplify the structure of the processor. As a result, there is an effect that it is possible to obtain a SIMD type processor capable of efficiently carrying out a parallel processing.

According to the parallel processing apparatus of this invention, the parallel processing unit carries out a parallel processing using a plurality of arithmetic units which carry out an arithmetic processing to given data. Further, the data providing unit provides data to be arithmetically processed to the parallel processing unit. The instruction providing unit provides the same instruction for carrying out the arithmetic processing to each of the arithmetic unit. The input unit inputs an interruption request for carrying out other parallel processing by interrupting a parallel processing currently carried out by the parallel processing unit. The decision unit makes a decision as to whether a parallel processing requested by the interruption request input from the input unit is to be carried out or not. The suspending unit suspends a parallel processing currently being carried out by the parallel processing unit when the decision unit has decided that the interruption processing is to be carried out. The control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units. Therefore, it is possible to execute the interruption processing by instantly suspending the processing. As a result, there is an effect that it is possible to obtain a parallel processing apparatus capable of efficiently carrying out a parallel processing.

Further, the parallel processing apparatus further includes the instruction storing unit that stores the instruction. Therefore, it is possible to execute the parallel processing including the interruption processing, by incorporating the instruction necessary for the parallel processing including the interruption processing. As a result, there is an effect that it is possible to obtain a parallel processing apparatus capable of efficiently carrying out a parallel processing.

Further, the parallel processing apparatus further includes the storing unit that stores suspension information consisting of data and an instruction at a point of time when a parallel processing has been suspended by the suspending unit. Further, the detecting unit detects whether the interruption processing has been finished or not. The transmission unit transmits suspension information stored by the storing unit to an original position when the detecting unit has detected a finish of the interruption processing. Therefore, it is possible to store a state of the suspended processing into the computer and to return to the state of the suspended processing. As a result, there is an effect that it is possible to obtain a parallel processing apparatus capable of efficiently carrying out a parallel processing.

Further, the parallel processing apparatus further includes a program counter, and an accumulator that is used in the arithmetic units. The program counter assigns an instruction stored by the instruction storing unit, and each arithmetic units carries out the arithmetic processing using the accumulator. Therefore, it is possible to carry out a processing of what is called one-address system, which makes it possible to shorten the length of the instruction. As a result, there is an effect that it is possible to obtain a parallel processing apparatus capable of efficiently carrying out a parallel processing.

Further, the parallel processing apparatus further includes a program counter; an accumulator and a resistor that are used in the arithmetic units; and a data register that stores data provided by the data providing unit. The suspension information consists of a program counter value, contents of the accumulator and the register, and data stored in the data register, at a point of time when a parallel processing has been suspended by the suspending unit. Therefore, it is possible to restore a state of the processor to a state at a point of time when the processing has been suspended, without decoding from the beginning the processing instructions that have been used for the parallel processing when this processing has been suspended. As a result, there is an effect that it is possible to obtain a parallel processing apparatus capable of efficiently carrying out a parallel processing.

Further, in the parallel processing apparatus, the storing unit stores various parameter data that are necessary for the arithmetic processing carried out by the arithmetic units. Therefore, it is possible to simplify the management of the bus. As a result, there is an effect that it is possible to obtain a parallel processing apparatus capable of efficiently carrying out a parallel processing.

According to the image processing apparatus of the present invention there is provided the image data control unit. This image control unit is connected to an image memory control unit that controls an image reader that reads image data and/or an image memory thereby to write/read image data and/or an image writer that writes image data onto a transcription sheet; and an image processing unit that carries out an image processing of image data such as an editing of image data. The image control unit receives at least third image data out of first image data that has been read by the image reader, second image data that has been read by the image memory control unit, and the third image data that has been image processed by the image processing unit. The image control unit transmits at least the third image data out of the first image data, the second image data, and the third imaged data, to the image memory control unit and/or the image processing unit and/or the image writer. At least the image processing unit out of all the units has the SIMD type processor or the parallel processing apparatus according to the present invention. Therefore, it is possible to optimize the performance of the processing of the image data, using the SIMD type processor or the parallel processing apparatus that can carry out an interruption processing. As a result, there is an effect that it is possible to obtain an image processing apparatus capable of carrying out an optimum image processing of the system as a whole, while effectively utilizing the resources of the system in realizing the multi-functions.

According to the image processing apparatus of the present invention there is provided the image data control unit. This image control unit is connected to an image reader that reads image data and/or an image writer that writes image data onto a transcription sheet; and an image processing unit that carries out an image processing of image data such as an editing of image data. The image memory control unit receives at least second image data out of first image data that has been read by the image reader, and the second image data that has been image processed by the image processing unit. The image memory control unit stores at least the second image data out of the first image data and the second image data, into an image memory, and transmits the image data stored in the image memory to the image processing unit and/or the image writer. At least the image processing unit out of all the units has the SIMD type processor or the parallel processing apparatus according to the present invention. Therefore, it is possible to effectively utilize the image memory and to optimize the processing of a stored image via the SIMD type processor or the parallel processing apparatus that can carry out an interruption processing. As a result, there is an effect that it is possible to obtain an image processing apparatus capable of carrying out an optimum image processing of the system as a whole, while effectively utilizing the resources of the system in realizing the multi-functions.

Further, in the image processing apparatus, the image memory control unit is connected to the image processing unit, the image reader and/or the image writer via the image data control unit, and the image data control unit transmits and receives image data between the image memory control unit, the image processing unit, the image reader and/or the image writer. Therefore, it is possible to optimize the adaptation of the image memory control unit to the input/output device. As a result, there is an effect that it is possible to obtain an image processing apparatus capable of carrying out an optimum image processing in the system as a whole, while effectively utilizing the resources of the system in realizing the multi-functions.

Further, in the image processing apparatus, image processing unit is connected to an image reader that reads image data and/or image memory a control unit that controls an image memory to write/read image data and/or an image writer that writes image data onto a transcription sheet. The image processing unit receives first image data that has been read by the image reader and/or second image data that has been read by the image memory control unit. The image processing unit carries out an image processing of the first image data and/or the second image data such as an editing of image data, and transmits the image-processed image data to the image memory control unit and/or the image writer. At least the image processing unit out of all the units has the SIMD type processor or the parallel processing apparatus according to the present invention. Therefore, it is possible to optimize the image processing by using the SIMD type processor or the parallel processing apparatus that can carry out an interruption processing. As a result, there is an effect that it is possible to obtain an image processing apparatus capable of carrying out an optimum image processing in the system as a whole, while effectively utilizing the resources of the system in realizing the multi-functions.

Further, in the image processing apparatus, the image processing unit is connected to the image reader and/or the image memory control unit and/or the image writer via the image data control unit, and the image data control unit transmits and receives image data between the image processing unit, the image reader and/or the image memory control unit and/or the image writer. Therefore, it is possible to control the adaptation of the image processing to the input/output device. As a result, there is an effect that it is possible to obtain an image processing apparatus capable of carrying out an optimum image processing in the system as a whole, while effectively utilizing the resources of the system in realizing the multi-functions.

Further, in the image processing apparatus, facsimile control unit is connected to the image memory control unit and/or the image data control unit, and carries out transmission and reception of a facsimile image. Therefore, it is possible to effectively utilize the image memory in the transmission/reception processing of a facsimile image, and to carry out the image processing using the SIMD type processor or the parallel processing apparatus that can carry out an interruption processing of the input/output image data. As a result, there is an effect that it is possible to obtain an image processing apparatus capable of carrying out an optimum image processing in the system as a whole, while effectively utilizing the resources of the system in realizing the multi-functions.

Further, in the image processing apparatus, the image reader and/or the image data control unit and/or the image memory control unit and/or the image processing unit and/or the image writer an/or the facsimile control unit are structured as independent units respectively. Therefore, the manufacture of devices can be easily divided, and it is possible to construct a multi-function system at low cost. As a result, there is an effect that it is possible to obtain an image processing apparatus capable of carrying out an optimum image processing in the system as a whole, while effectively utilizing the resources of the system in realizing the multi-functions.

Further, according to the present invention, there is provided a copier including the SIMD type processor according to any one of the above inventions or the parallel processing apparatus according to any one of the above inventions. Therefore, it is possible to make the copier for carrying out a parallel processing of image data execute an interruption processing. As a result, there is an effect that it is possible to obtain a copier capable of efficiently carry out a parallel processing.

Further, according to the present invention, there is provided a printer including the SIMD type processor according to any one of the above inventions or the parallel processing apparatus according to any one of the above inventions. Therefore, it is possible to make the printer for carrying out a parallel processing of image data execute an interruption processing. As a result, there is an effect that it is possible to obtain a printer capable of efficiently carry out a parallel processing.

Further, according to the present invention, there is provided a facsimile machine including the SIMD type processor according to any one of the above inventions or the parallel processing apparatus according to any one of the above inventions. Therefore, it is possible to make the facsimile machine for carrying out a parallel processing of image data execute an interruption processing. As a result, there is an effect that it is possible to obtain a facsimile machine capable of efficiently carry out a parallel processing.

Further, according to the present invention, there is provided a scanner including the SIMD type processor according to any one of the above inventions or the parallel processing apparatus according to any one of the above inventions. Therefore, it is possible to make the scanner for carrying out a parallel processing of image data execute an interruption processing. As a result, there is an effect that it is possible to obtain a scanner capable of efficiently carry out a parallel processing.

The parallel processing method according to the present invention includes a data providing step of providing data to be processed as a parallel processing; an instruction providing step of providing an instruction necessary for carrying out the parallel processing; a parallel-processing step of carrying out a parallel processing of the data provided at the data providing step, based on the instruction provided at the instruction providing step; an input step of inputting an interruption request for carrying out other parallel processing by interrupting a parallel processing currently carried out at the parallel-processing step; a decision step of making a decision as to whether an interruption processing of the parallel processing requested at the input step is to be carried out or not; a suspending step of suspending a parallel processing currently being carried out at the parallel-processing step when a decision has been made at the decision step that the interruption processing is to be carried out; and a replacing step of providing data to be parallel processed by the interruption processing and an instruction necessary for carrying out the interruption processing, in place of the parallel processing suspended at the suspending step. Therefore, it is possible to execute the interruption processing by instantly suspending the processing. As a result, there is an effect that it is possible to obtain a parallel processing method capable of efficiently carrying out a parallel processing.

Further, the parallel processing method further includes a saving step of saving data and an instruction at a point of time when a parallel processing has been suspended at the suspending step; a detecting step of detecting whether the interruption processing has been finished or not; and a restoring step of restoring the data and the instruction saved at the saving step to an original state at the point of time when the processing has been suspended at the suspending step, when a finish of the interruption processing has been detected at the detecting step. Therefore, it is possible to save and restore the suspended parallel processing. As a result, there is an effect that it is possible to obtain a parallel processing method capable of efficiently carrying out a parallel processing.

The parallel processing method according to another aspect of this invention includes an image data receiving step of receiving image data from any one processing unit out of a plurality of processing units that carry out different kinds of processing of image data such as an image data reading processing, an image data storing processing, an image (editing) processing, and a transmission/reception processing; an image data control information obtaining step of obtaining image data control information that includes information relating to the contents of processing of the image data received at the image data receiving step; a transmission destination processing unit determining step of determining a processing unit at a transmission destination to which the image data received at the image data receiving step is to be transmitted, based on the image data control information obtained at the image data control information obtaining step; and a transmission step of transmitting the image data to the transmission destination processing unit that has been determined at the transmission destination processing unit determining step. The processing of the image data in at least one processing unit among the plurality of processing units includes the parallel processing method of the above invention. Therefore, it is possible to optimize the processing performance of the image data by carrying out an interruption processing in place of the parallel processing currently under execution. As a result, there is an effect that it is possible to obtain an image processing method capable of carrying out an optimum image processing of the system as a whole, while effectively utilizing the resources of the system in realizing the multi-functions.

Further, the image processing method further includes a control information input step of inputting the image data control information. At the image data control information obtaining step, the image data control information input at the control information input step is obtained. Therefore, it is possible to optimize the processing performance of the image data based on the image data control information that has been input. As a result, there is an effect that it is possible to obtain an image processing method capable of carrying out an optimum image processing of the system as a whole, while effectively utilizing the resources of the system in realizing the multi-functions.

Further, the image processing method is used for a correction processing for correcting information deterioration of image data or a picture quality processing corresponding to image data corrected by the correction processing or image data corresponding to an image forming characteristic. Therefore, it is possible to optimize the image processing of the image data. As a result, there is an effect that it is possible to obtain an image processing method capable of carrying out an optimum image processing of the system as a whole, while effectively utilizing the resources of the system in realizing the multi-functions.

Further, according to the present invention, there is provided a recording medium recorded with a program that makes a computer execute the method according to any one of the above inventions. Therefore, the computer can read this program. As a result, there is an effect that it is possible to obtain a recording medium capable of achieving the operation of the above inventions by the computer.

The present document incorporates by reference the entire contents of Japanese priority document, 2000-087580 filed in Japan on Mar. 27, 2000.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A SIMD type processor comprising:
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

2. The SIMD type processor according to claim 1, further comprising an instruction storing unit that stores the instruction.

3. The SIMD type processor according to claim 1, further comprising:
a storing unit that stores suspension information consisting of data and an instruction at a point of time when a parallel processing has been suspended by the suspending unit;
a detecting unit that detects whether the interruption processing has been finished or not; and
a transmission unit that transmits the suspension information stored by the storing unit to an original position when the detecting unit has detected a finish of the interruption processing.

4. The SIMD type processor according to claim 2, further comprising:
a program counter; and
an accumulator that is used in the arithmetic units,
wherein the program counter assigns an instruction stored by the instruction storing unit, and each arithmetic units carries out the arithmetic processing using the accumulator.

5. The SIMD type processor according to claim 3, further comprising:
a program counter;
an accumulator and a resistor that are used in the arithmetic units; and
a data register that stores data provided by the data providing unit,
wherein the suspension information consists of a program counter value, contents of the accumulator and the register, and data stored in the data register, at a point of time when a parallel processing has been suspended by the suspending unit.

6. The SIMD type processor according to claim 3,
wherein the storing unit stores various parameter data that are necessary for the arithmetic processing carried out by the arithmetic units.

7. An image processing apparatus comprising:
an image data control unit connected to,
an image memory control unit that controls an image reader that reads image data and/or an image memory thereby to write/read image data and/or an image writer that writes image data onto a transcription sheet; and
an image processing unit that carries out an image processing of image data such as an editing of image data,
that receives at least third image data out of first image data that has been read by the image reader, second image data that has been read by the image memory control unit, and said third image data that has been image processed by the image processing unit, and
that transmits at least the third image data out of the first image data, the second image data, and the third imaged data, to the image memory control unit and/or the image processing unit and/or the image writer,
wherein at least the image processing unit has a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

8. An image processing apparatus comprising:
an image memory control unit connected to,
an image reader that reads image data and/or an image writer that writes image data onto a transcription sheet; and
an image processing unit that carries out an image processing of image data such as an editing of image data,
that receives at least second image data out of first image data that has been read by the image reader, and said second image data that has been image processed by the image processing unit, and
that stores at least the second image data out of the first image data and the second image data, into an image memory, and transmits the image data stored in the image memory to the image processing unit and/or the image writer,
wherein at least the image processing unit has a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

9. The image processing apparatus according to claim 8,
wherein the image memory control unit is connected to the image processing unit, the image reader and/or the image writer via the image data control unit, and
the image data control unit transmits and receives image data between the image memory control unit, the image processing unit, the image reader and/or the image writer.

10. The image processing apparatus comprising:
an image processing unit that is connected to an image reader that reads image data and/or image memory a control unit that controls an image memory to write/read image data and/or an image writer that writes image data onto a transcription sheet,
that receives first image data that has been read by the image reader and/or second image data that has been read by the image memory control unit, and
that carries out an image processing of the first image data and/or the second image data such as an editing of image data, and transmits the image-processed image data to the image memory control unit and/or the image writer, wherein
at least the image processing unit has a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

11. The image processing apparatus according to claim 10,
wherein the image processing unit is connected to the image reader and/or the image memory control unit and/or the image writer via the image data control unit, and
the image data control unit transmits and receives image data between the image processing unit, the image reader and/or the image memory control unit and/or the image writer.

12. The image processing apparatus according to claim 7, further comprising:
a facsimile control unit that is connected to the image memory control unit and/or the image data control unit, and that carries out transmission and reception of a facsimile image.

13. The image processing apparatus according to claim 8, further comprising:
a facsimile control unit that is connected to the image memory control unit and/or the image data control unit, and that carries out transmission and reception of a facsimile image.

14. The image processing apparatus according to claim 10, further comprising:
a facsimile control unit that is connected to the image memory control unit and/or the image data control unit, and that carries out transmission and reception of a facsimile image.

15. The image processing apparatus according to claim 7,
wherein the image reader and/or the image data control unit and/or the image memory control unit and/or the image processing unit and/or the image writer an/or the facsimile control unit are structured as independent units respectively.

16. The image processing apparatus according to claim 8,
wherein the image reader and/or the image data control unit and/or the image memory control unit and/or the image processing unit and/or the image writer an/or the facsimile control unit are structured as independent units respectively.

17. The image processing apparatus according to claim 10,
wherein the image reader and/or the image data control unit and/or the image memory control unit and/or the image processing unit and/or the image writer an/or the facsimile control unit are structured as independent units respectively.

18. A copier comprising a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

19. A printer comprising a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

20. A facsimile machine comprising a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

21. A scanner comprising a SIMD type processor, which SIMD type processor includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

22. A parallel processing apparatus comprising:
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

23. The parallel processing apparatus according to claim 22, further comprising an instruction storing unit that stores the instruction.

24. The parallel processing apparatus according to claim 22, further comprising:
a storing unit that stores suspension information consisting of data and an instruction at a point of time when a parallel processing has been suspended by the suspending unit;
a detecting unit that detects whether the interruption processing has been finished or not; and
a transmission unit that transmits the suspension information stored by the storing unit to an original position when the detecting unit has detected a finish of the interruption processing.

25. The parallel processing apparatus according to claim 22, further comprising:
a program counter; and
an accumulator that is used in the arithmetic units,
wherein the program counter assigns an instruction stored by the instruction storing unit, and each arithmetic units carries out the arithmetic processing using the accumulator.

26. The parallel processing apparatus according to claim 24, further comprising:
a program counter;
an accumulator and a resistor that are used in the arithmetic units; and
a data register that stores data provided by the data providing unit,
wherein the suspension information consists of a program counter value, contents of the accumulator and the register, and data stored in the data register, at a point of time when a parallel processing has been suspended by the suspending unit.

27. The parallel processing apparatus according to claim 24,
wherein the storing unit stores various parameter data that are necessary for the arithmetic processing carried out by the arithmetic units.

28. An image processing apparatus comprising:
an image data control unit connected to,
an image memory a control unit that controls an image reader that reads image data and/or an image memory thereby to write/read image data and/or an image writer that writes image data onto a transcription sheet; and
an image processing unit that carries out an image processing of image data such as an editing of image data,
that receives at least third image data out of first image data that has been read by the image reader, second image data that has been read by the image memory control unit, and said third image data that has been image processed by the image processing unit, and
that transmits at least the third image data out of the first image data, the second image data, and the third imaged data, to the image memory control unit and/or the image processing unit and/or the image writer,
wherein at least the image processing unit out of all said units has a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

29. An image processing apparatus comprising:
an image memory control unit connected to,
an image reader that reads image data and/or an image writer that writes image data onto a transcription sheet; and
an image processing unit that carries out an image processing of image data such as an editing of image data,
that receives at least second image data out of first image data that has been read by the image reader, and said second image data that has been image processed by the image processing unit, and
that stores at least the second image data out of the first image data and the second image data, into an image memory, and transmits the image data stored in the image memory to the image processing unit and/or the image writer,
wherein at least the image processing unit out of all said units has a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

30. The image processing apparatus according to claim 29,
wherein the image memory control unit is connected to the image processing unit, the image reader and/or the image writer via the image data control unit, and
the image data control unit transmits and receives image data between the image memory control unit, the image processing unit, the image reader and/or the image writer.

31. The image processing apparatus comprising:
image processing unit connected to an image reader that reads image data and/or image memory a control unit that controls an image memory to write/read image data and/or an image writer that writes image data onto a transcription sheet,
that receives first image data that has been read by the image reader and/or second image data that has been read by the image memory control unit, and
that carries out an image processing of the first image data and/or the second image data such as an editing of image data, and transmits the image-processed image data to the image memory control unit and/or the image writer,
wherein at least the image processing unit out of all said units has a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

32. The image processing apparatus according to claim 31,
wherein the image processing unit is connected to the image reader and/or the image memory control unit and/or the image writer via the image data control unit, and
the image data control unit transmits and receives image data between the image processing unit, the image reader and/or the image memory control unit and/or the image writer.

33. The image processing apparatus according to claim 28, further comprising:
a facsimile control unit that is connected to the image memory control unit and/or the image data control unit, and that carries out transmission and reception of a facsimile image.

34. The image processing apparatus according to claim 29, further comprising:
a facsimile control unit that is connected to the image memory control unit and/or the image data control unit, and that carries out transmission and reception of a facsimile image.

35. The image processing apparatus according to claim 31, further comprising:
a facsimile control unit that is connected to the image memory control unit and/or the image data control unit, and that carries out transmission and reception of a facsimile image.

36. The image processing apparatus according to claim 28,
wherein the image reader and/or the image data control unit and/or the image memory control unit and/or the image processing unit and/or the image writer an/or the facsimile control unit are structured as independent units respectively.

37. The image processing apparatus according to claim 29,
wherein the image reader and/or the image data control unit and/or the image memory control unit and/or the image processing unit and/or the image writer an/or the facsimile control unit are structured as independent units respectively.

38. The image processing apparatus according to claim 31,
wherein the image reader and/or the image data control unit and/or the image memory control unit and/or the image processing unit and/or the image writer an/or the facsimile control unit are structured as independent units respectively.

39. A copier comprising a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

40. A printer comprising a parallel processing apparatus, which parallel processing apparatus includes, a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

41. A facsimile machine comprising a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

42. A scanner comprising a parallel processing apparatus, which parallel processing apparatus includes,
a parallel processing unit that carries out a parallel processing using a plurality of arithmetic units which carry out an arithmetic processing to given data;
a data providing unit that provides data to be arithmetically processed to the parallel processing unit;
an instruction providing unit that provides the same instruction for carrying out the arithmetic processing to each of the arithmetic unit;
an input unit that inputs an interruption request for carrying out other parallel processing by interrupting a parallel processing currently carried out by the parallel processing unit;
a decision unit that makes a decision as to whether a parallel processing requested by the interruption request input from the input unit is to be carried out or not;
a suspending unit that suspends a parallel processing currently being carried out by the parallel processing unit when the decision unit has decided that the interruption processing is to be carried out; and
a control unit that controls the data providing unit and the instruction providing unit so as to provide data to be arithmetically processed by the interruption processing to the parallel processing unit in place of the parallel processing suspended by the suspending unit and to provide the same instruction necessary for carrying out the interruption processing to each of the arithmetic units.

43. A parallel processing method comprising:
a data providing step of providing data to be processed as a parallel processing;
an instruction providing step of providing an instruction necessary for carrying out the parallel processing;
a parallel-processing step of carrying out a parallel processing of the data provided at the data providing step, based on the instruction provided at the instruction providing step;
an input step of inputting an interruption request for carrying out other parallel processing by interrupting a parallel processing currently carried out at the parallel-processing step;
a decision step of making a decision as to whether an interruption processing of the parallel processing requested at the input step is to be carried out or not;
a suspending step of suspending a parallel processing currently being carried out at the parallel-processing step when a decision has been made at the decision step that the interruption processing is to be carried out; and
a replacing step of providing data to be parallel processed by the interruption processing and an instruction necessary for carrying out the interruption processing, in place of the parallel processing suspended at the suspending step.

44. The parallel processing method according to claim 43, further comprising:
a saving step of saving data and an instruction at a point of time when a parallel processing has been suspended at the suspending step;
a detecting step of detecting whether the interruption processing has been finished or not; and
a restoring step of restoring the data and the instruction saved at the saving step to an original state at the point of time when the processing has been suspended at the suspending step, when a finish of the interruption processing has been detected at the detecting step.

45. An image processing method comprising:
an image data receiving step of receiving image data from any one processing unit out of a plurality of processing units that carry out different kinds of processing of image data such as an image data reading processing, an image data storing processing, an image (editing) processing, and a transmission/reception processing;
an image data control information obtaining step of obtaining image data control information that includes information relating to the contents of processing of the image data received at the image data receiving step;
a transmission destination processing unit determining step of determining a processing unit at a transmission destination to which the image data received at the image data receiving step is to be transmitted, based on the image data control information obtained at the image data control information obtaining step; and
a transmission step of transmitting the image data to the transmission destination processing unit that has been determined at the transmission destination processing unit determining step, wherein
the processing of the image data in at least one processing unit among the plurality of processing units includes a parallel processing method, which parallel processing method includes the steps of,
a data providing step of providing data to be processed as a parallel processing;
an instruction providing step of providing an instruction necessary for carrying out the parallel processing;
a parallel-processing step of carrying out a parallel processing of the data provided at the data providing step, based on the instruction provided at the instruction providing step;
an input step of inputting an interruption request for carrying out other parallel processing by interrupting a parallel processing currently carried out at the parallel-processing step;
a decision step of making a decision as to whether an interruption processing of the parallel processing requested at the input step is to be carried out or not;
a suspending step of suspending a parallel processing currently being carried out at the parallel-processing step when a decision has been made at the decision step that the interruption processing is to be carried out; and
a replacing step of providing data to be parallel processed by the interruption processing and an instruction necessary for carrying out the interruption processing, in place of the parallel processing suspended at the suspending step.

46. The image processing method according to claim 45, further comprising a control information input step of inputting the image data control information,
wherein at the image data control information obtaining step, the image data control information input at the control information input step is obtained.

47. The image processing method according to claim 45,
wherein the image processing method is used for a correction processing for correcting information deterioration of image data or a picture quality processing corresponding to image data corrected by the correction processing or image data corresponding to an image forming characteristic.

48. A computer readable medium for storing instructions, which when executed on a computer, causes the computer to perform the steps of:
a data providing step of providing data to be processed as a parallel processing;
an instruction providing step of providing an instruction necessary for carrying out the parallel processing;
a parallel-processing step of carrying out a parallel processing of the data provided at the data providing step, based on the instruction provided at the instruction providing step;
an input step of inputting an interruption request for carrying out other parallel processing by interrupting a parallel processing currently carried out at the parallel-processing step;
a decision step of making a decision as to whether an interruption processing of the parallel processing requested at the input step is to be carried out or not;
a suspending step of suspending a parallel processing currently being carried out at the parallel-processing step when a decision has been made at the decision step that the interruption processing is to be carried out; and
a replacing step of providing data to be parallel processed by the interruption processing and an instruction necessary for carrying out the interruption processing, in place of the parallel processing suspended at the suspending step.

49. A computer readable medium for storing instructions, which when executed on a computer, causes the computer to perform the steps of:
an image data receiving step of receiving image data from any one processing unit out of a plurality of processing units that carry out different kinds of processing of image data such as an image data reading processing, an image data storing processing, an image (editing) processing, and a transmission/reception processing;
an image data control information obtaining step of obtaining image data control information that includes information relating to the contents of processing of the image data received at the image data receiving step;
a transmission destination processing unit determining step of determining a processing unit at a transmission destination to which the image data received at the image data receiving step is to be transmitted, based on the image data control information obtained at the image data control information obtaining step; and
a transmission step of transmitting the image data to the transmission destination processing unit that has been determined at the transmission destination processing unit determining step, wherein
the processing of the image data in at least one processing unit among the plurality of processing units includes a parallel processing method, which parallel processing method includes the steps of,
a data providing step of providing data to be processed as a parallel processing;
an instruction providing step of providing an instruction necessary for carrying out the parallel processing;
a parallel-processing step of carrying out a parallel processing of the data provided at the data providing step, based on the instruction provided at the instruction providing step;
an input step of inputting an interruption request for carrying out other parallel processing by interrupting a parallel processing currently carried out at the parallel-processing step;
a decision step of making a decision as to whether an interruption processing of the parallel processing requested at the input step is to be carried out or not;
a suspending step of suspending a parallel processing currently being carried out at the parallel-processing step when a decision has been made at the decision step that the interruption processing is to be carried out; and
a replacing step of providing data to be parallel processed by the interruption processing and an instruction necessary for carrying out the interruption processing, in place of the parallel processing suspended at the suspending step.
